(19) United States
(12) Patent Application Publication
(10) Pub. No.: US 2014/0143391 A1
(43) Pub. Date: May 22, 2014

(54) COMPUTER SYSTEM AND VIRTUAL SERVER MIGRATION CONTROL METHOD FOR COMPUTER SYSTEM

(71) Applicant: Hitachi, Ltd., Tokyo (JP)

(72) Inventors: Keiko Tanigawa, Yokohama-shi (JP); Keisuke Hatasaki, Kawasaki-shi (JP)

(73) Assignee: Hitachi, Ltd., Tokyo (JP)

(21) Appl. No.: 13/702,397

(22) PCT Filed: Nov. 20, 2012
(86) PCT No.: PCT/JP12/07456

§ 371 Date: Dec. 6, 2012

(51) Int. Cl. H04L 29/08

(52) U.S. Cl. CPC H04L 67/06
USPC 709/221

(57) ABSTRACT

A computer system suited for migration of a virtual server between a plurality of physical servers that do not share a storage apparatus via a network is provided. The present invention is a computer system configured to: couple a plurality of computers together, in each of which a plurality of physical servers and a storage apparatus are directly connected within the same chassis, by directly connecting the storage apparatuses of the plurality of computers: and further have a management computer manage the plurality of computers. When the management computer selects another physical server other than a first physical server in a first computer among the plurality of computers as a migration destination of a virtual server, which operates in the first physical server in the first computer, it judges whether the other physical server exists in the first computer or exists in another computer different from the first computer among the plurality of computers.

### TECHNICAL FIELD

The present invention relates to a computer system and a virtual server migration control method for the computer system. Specifically speaking, the invention relates to: a computer system characterized in that a virtual server is migrated between a plurality of physical servers and a storage area used by the virtual server is also migrated between a plurality of storage apparatuses; and a virtual server migration method for the computer system.

### BACKGROUND ART

Recently, server virtualization technology has become widespread and it is common to integrate a plurality of virtual servers on single hardware (physical server). Furthermore, its purpose is not only to reduce capital investment, but techniques to operate an information system more flexibly have been developed. For example, there are a technique to complete the introduction of a server to users by means of template management of a virtual server, which has been set, simply by creating a copy of a virtual disk used by the virtual server, and a technique to cancel hot spots such as the occurrence of a failure or load unbalance by, for example, detecting the hot spots and dynamically changing a logical configuration of the virtual server, and migrating a virtual server to hardware capable of securing sufficient resources.

For example, there is also a technique to realize migration of a virtual server by connecting a migration source physical server, in which the virtual server is mounted, and a migration destination physical server of the virtual server to a shared storage apparatus, which stores virtual disks, via a SAN (Storage Area Network) and promptly transferring the operating status of an active memory of the virtual machine to the migration destination physical server via the network (see U.S. Pat. No. 7,484,208).

### CITATION LIST

### Patent Literature

[PTL 1]
U.S. Pat. No. 7,484,208

### SUMMARY OF INVENTION

### Technical Problem

Conventional systems are configured so that physical servers and storage apparatuses are connected by a SAN and the plurality of physical servers share the storage apparatuses via the SAN. However, with this type of systems, not all the physical server necessarily share all the storage apparatuses and problems specific to network systems such as the number of connections and a high cost of SAN switches have become prominent. Furthermore, particularly increases of network data transfer load and transfer cost required when the physical servers share the storage apparatus(es) can no longer be ignored due to an increase of unstructured data.

So, it is an object of the present invention to solve the problems such as the inevitable occurrence of data transfer via the SAN because of the connection between the physical servers and the storage apparatus(es) being loose coupling, and the increasing cost of the SAN due to scale expansion of the system. Also, in consideration of the resolution of the above-described problems, it is another object of the present invention to realize proper processing when migrating a virtual server between a plurality of physical servers, which do not share a storage apparatus via a network, and to reduce the processing cost.

### Solution to Problem

The present invention which achieves the above-described objects is a computer system configured to: couple a plurality of computers together, in each of which a plurality of physical servers and a storage apparatus are directly connected within the same chassis, by connecting the storage apparatuses of the plurality of computers; and further allow a management computer to manage the plurality of computers.

The management computer is characterized in that if another physical server other than a first physical server in a first computer among the plurality of computers is selected as a migration destination of a virtual server that operates in the first physical server, the management computer judges whether the other physical server exists in the first computer or exists in another computer different from the first computer among the plurality of computers. Then, when migrating the virtual server from the first physical server to the other physical server based on the judgment result, the management computer resets the correspondence relationship between the virtual server and a storage area used by the virtual server to a computer to which the other physical server belongs.

With the system for coupling the plurality of computers together, in each of which a plurality of physical servers and a storage apparatus are directly connected within the same chassis, by connecting the storage apparatuses of the plurality of computers, a method for setting the correspondence relationship between the virtual server and a volume of the storage apparatus varies depending on whether the virtual server is to be migrated to another physical server existing in the same chassis or the virtual server is to be migrated to a physical server existing in another chassis.

Furthermore, another embodiment of the present invention provides a computer system including a plurality of computers, each of which includes: a plurality of physical servers; and at least one storage apparatus directly connected to the plurality of physical servers; and the computer system includes: a management device; a first network for connecting the plurality of computers to the management device; and a second network for connecting the respective storage apparatuses of the plurality of computers to each other; wherein when migrating a virtual server, which operates in a first physical server of a first computer among the plurality of computers, to another physical server other than the first physical server, if it is determined that the other physical server exists in another computer different from the first computer, the management device copies data stored in a storage area used by the virtual server to a storage apparatus of the other computer via the second network; and if the other physical server exists in the first computer, the management device does not copy the data stored in the storage area used by the virtual server.

Furthermore, another embodiment of the present invention provides a virtual server migration control method for a computer system with a management device for managing a plurality of computers, each of which includes a plurality of physical servers and at least one storage apparatus directly connected to the plurality of physical servers, wherein if the management device selects another physical server other than a first physical server in a first computer among the plurality of computers as a migration destination of a virtual server which operates in the first physical server in the first computer among the plurality of computers, the management device judges whether the other physical server exists in the first computer or exists in another computer different from the first computer among the plurality of computers; and if the virtual server is to be migrated from the first physical server to the other physical server existing in the other computer as a result of the judgment result, the management device resets a correspondence relationship between the virtual server and a storage area used by the virtual server to the other computer to which the other physical server belongs.

According to the present invention, the management computer can efficiently execute the operation to set the correspondence relationship between the storage area used by the virtual server and the virtual server upon migration of the virtual server by judging whether the migration destination physical server of the virtual server belongs to the same chassis as that of the virtual server or belongs to another chassis when migrating the virtual server.

### Advantageous Effects of Invention

According to the present invention, a computer system suited for migration of a virtual server between a plurality of physical servers which do not share a storage apparatus can be provided. Furthermore, with the computer system for migrating a virtual server between the plurality of physical servers which do not share a storage apparatus, the pre-migration connection relationship between the virtual server and the storage area can be maintained after the migration of the virtual server by utilizing a cooperative mechanism between a plurality of storage apparatuses even if the storage area used by the virtual server is migrated between the plurality of storage apparatuses.

### BRIEF DESCRIPTION OF DRAWINGS

FIG. 1 is a block configuration diagram of a computer system according to an embodiment of the present invention.

FIG. 2 shows an internal structure of a management server.

FIG. 3 shows an internal structure of a converged platform.

FIG. 4 shows an internal structure of a storage controller.

FIG. 5 shows a connection structure of target devices to be managed according to an embodiment of the present invention.

FIG. 6 is a block diagram of a computer system for migrating a virtual server(s) and a virtual disk(s) according to an embodiment of the present invention.

FIG. 7 shows a volume definition table.

FIG. 8 shows an allocation management table.

FIG. 9 shows a storage domain definition table.

FIG. 10 shows a port management table.

FIG. 11 shows a virtual disk management table.

FIG. 12 shows physical server information according to an embodiment of the present invention.

FIG. 13 shows a volume management table.

FIG. 14 shows a storage domain management table.

FIG. 15 shows a volume mapping table.

FIG. 16 shows a network management table.

FIG. 17 shows a migration target mapping table.

FIG. 18 shows a volume attachment design table.

FIG. 19 shows a virtual server migration management table.

FIG. 20 shows a CPF management table.

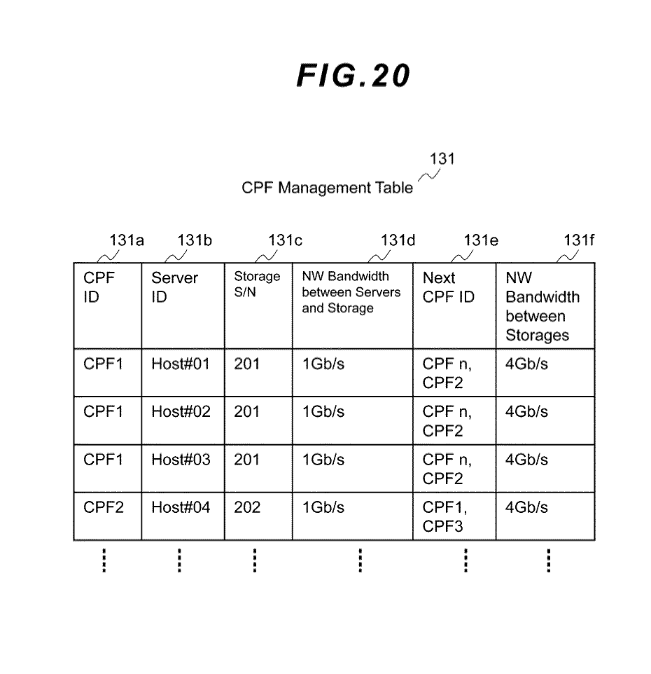

FIG. 21 shows a processing flow diagram of the computer system in FIG. 6.

FIG. 22 is a block diagram showing a plurality of CPFs connected in a ring form.

### DESCRIPTION OF EMBODIMENTS

With a computer system where a plurality of converged platforms (hereinafter referred to as CPF(s)), in each of which a plurality of physical servers are directly connected to a storage apparatus without the intermediary of a storage network and consolidated within a chassis, this embodiment provides a method for migrating a virtual server and its virtual disk from a physical server, in which the virtual server exists, to a different physical server by having a virtual server migration function provided by a virtualization program cooperate with an external connection function provided by the storage apparatus.

This embodiment utilizes a virtual server nonstop migration function by the virtualization program. This migration function enables migration of a virtual server without stopping it only by transferring the status of the virtual server, setting information, and data in a memory over the network when virtualization programs of the migration source physical server and the migration destination physical server share the volume which stores a virtual disk.

It is necessary to transfer and assign the status of applications, which are being executed on the virtual server, and data in use in the memory in order to migrate the virtual server without stopping to a different physical server; and a mechanism for making the virtualization programs operate in cooperation with each other is mounted on the computer system.

Furthermore, this migration function provided by the virtualization program is used often together with a load distribution function for a plurality of physical servers and a high reliability function (fail-over function) and it is unacceptable to wait for virtual disk migration time, so that the configuration to share a volume storing a virtual disk(s) is employed.

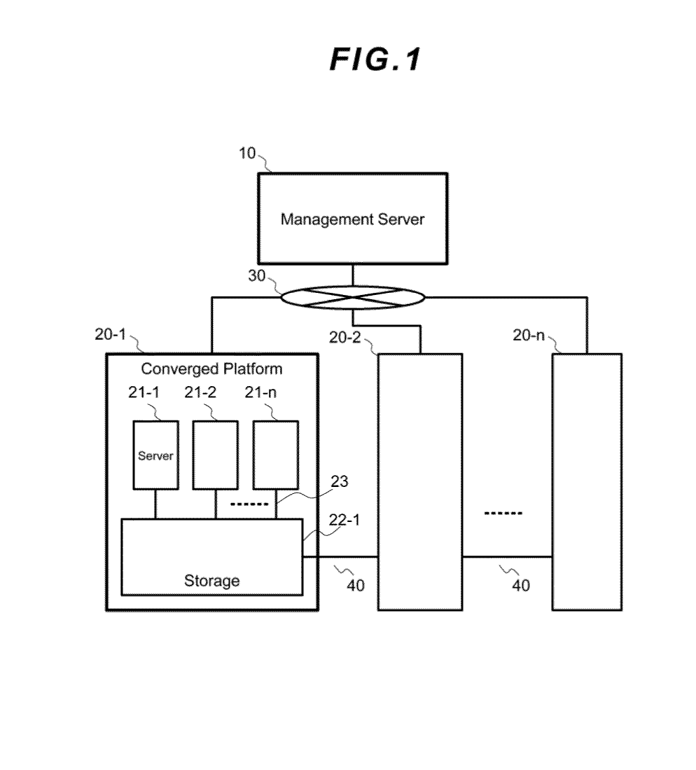

FIG. 1 shows a configuration example for a computer system according to this embodiment. This computer system is constituted from: a plurality of CPFs (CPF 20-1, 20-2, and so on up to 20-n), in each of which a plurality of physical servers 21-1, 21-2, and so on up to 21-n and a storage apparatus 22 are directly connected and are placed in the same chassis (CPF); and a management server 10. Each CPF 20 is connected to the management server 10 via a network 30 and storage apparatuses 22, each of which is contained in each CPF 20, are connected via a network 40. The network 30 is the Ethernet and the network 40 is, for example, a Fibre Channel.

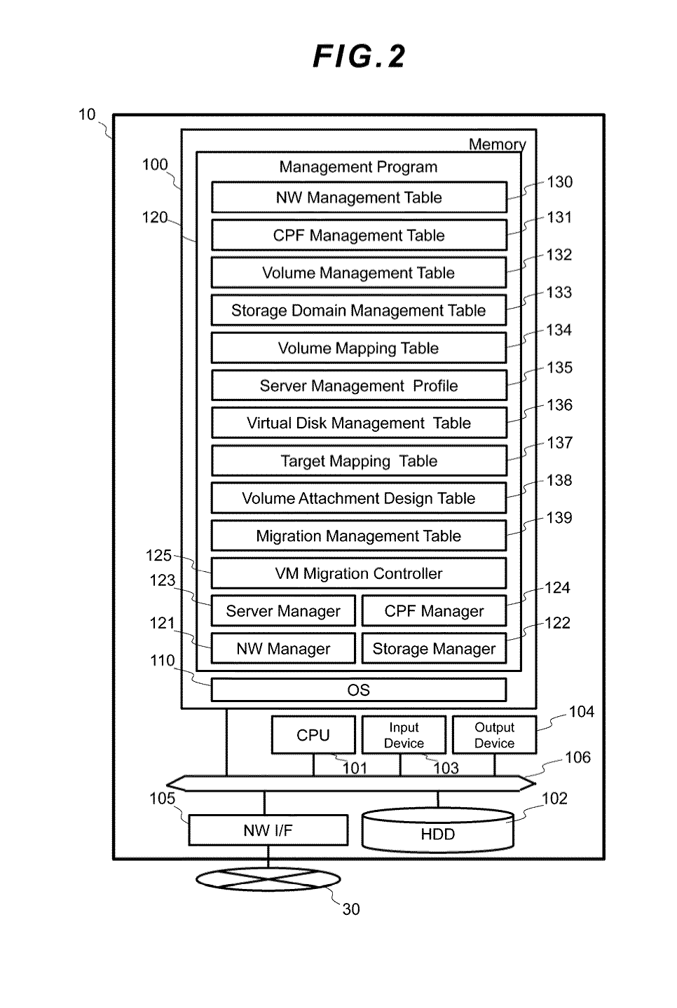

FIG. 2 shows an example of an internal structure of the management server 10. The management server 10 includes: a memory 100 storing an operating system (OS) 110 and management program 120, which are basic programs for controlling hardware and implementing information processing by using programs located at a higher level; a CPU 101 for executing software stored in the memory 100; an accumulation device 102; an input device 103 including a keyboard and a mouse; an output device 104 including a display; and a network interface (LAN interface) 105. These components are connected via a bus 106.

The management program 120 is constituted from a network manager 121, a storage manager 122, a physical server manager 123, a CPF manager 124, and a virtual server migration controller 125. Each management program and tables managed by each management program will be explained later.

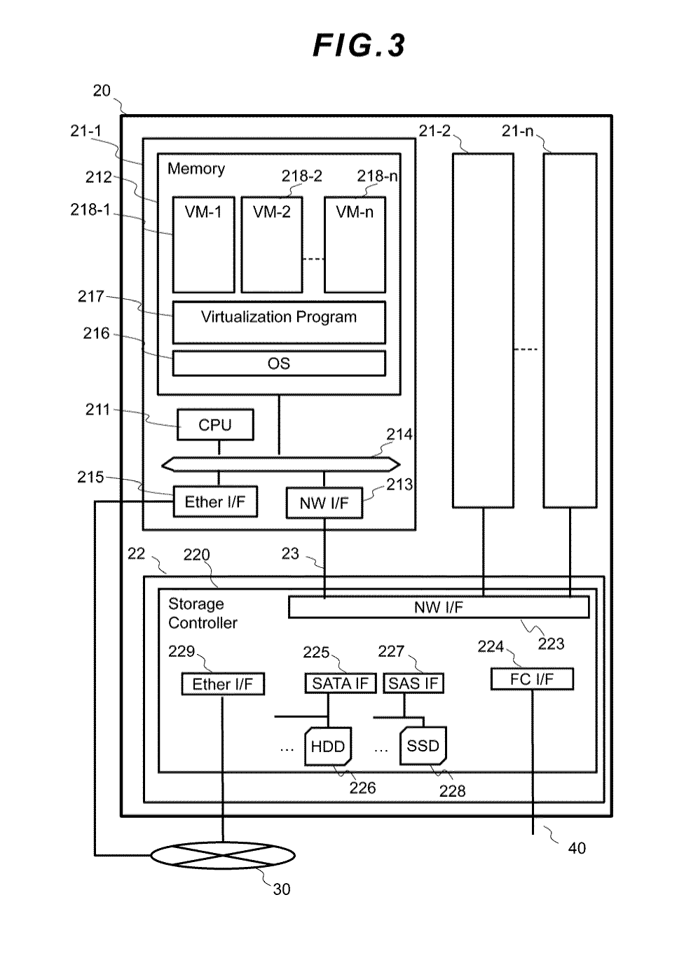

FIG. 3 shows an example of an internal structure of the CPF 20. The CPF 20 has at least one or more physical servers 21-1, 21-2, and so on up to 21-n and a storage apparatus 22, which are directly connected via network interfaces 213, 223, and includes an Ethernet interface 215 for connection with the management server 10 in each physical server.

The network 23 for directly connecting the physical server 21 (the branch number is omitted in this way when a plurality of physical servers are not distinguished one from another; and the same applies to other components) and the storage apparatus 22 includes, for example, networks in conformity with other standards such as Fiber Channel (FC), PCIe (Peripheral Component Interconnect Express), InfiniBand, FCoE (Fiber Channel over Ethernet).

For example, if the network 23 is an FC, each physical server 21 has an adapter HBA (Host Bus Adapter) 213 for containing the FC and is connected to the network interface 223 of the storage apparatus 22 via each HBA 213. The network interface 223 of the storage apparatus 22 may have as many HBAs as the number of the physical servers 21 or may be an HBA equipped with a plurality of ports.

The CPF 20 is configured to set the connection between the physical servers and the storage as a direct connection structure that is not routed through a switch. In other words, the CPF 20 realizes a configuration in which the physical server does not have a direct connection path to a storage apparatus of another CPF, unlike the networks 30, 40 constituting the connections between the plurality of CPFs. In this embodiment, the network 23 will be explained as an FC below.

The CPU 211 of each physical server 21-1, 21-2, and so on up to 21-n executes the OS 216, a virtualization program 217, one or more virtual servers (Virtual Machine(s): VM(s)) 218-1 and so on up to 218-n, which are stored in the memory 212.

The virtualization program 217 realizes a function logically dividing one piece of hardware into one or more virtual areas. The virtual server 218 operates application programs in a virtual hardware area divided by the virtualization program 217. An appropriate OS may be made to operate inside the virtual server in order to make the application programs operate. Functions of the OS 216 are similar to those of the virtualization program 217 in terms of abstraction of hardware and the virtualization program 217 may be mounted as part of the OS 216 in the physical server.

The storage apparatus 22 provides a storage area configured for each logical unit called a volume to equipment to be connected (for example, the physical server 21-1). The storage apparatus 22 has a storage controller 220 for intensively controlling each component such as a storage device like an HDD 226.

The storage controller 220 sends and receives data required by processing by programs and/or applications on the physical server 21 via the network interface 223. In this embodiment, the configuration where the physical servers and the storage apparatus are directly connected via the Fibre Channel is employed, so that the network interface 223 should be a Fibre Channel interface. For example, if the Fibre Channel is used to directly connect the network 40 for connecting a storage apparatus 22 of a certain CPF 20 (for example, the CPF 20-1) and a storage apparatus 22 of another CPF 20 (for example, the CPF 20-2), the connection is established via a Fibre Channel interface 224.

In this embodiment, the storage controller 220 provides storage areas to physical servers in accordance with SCSI (Small Computer System Interface) standards. The storage controller 220 includes a SATA (Serial Advanced Technology Attachment) interface 225 or SAS (Serial Attached SCSI) interface 227 for connecting to, for examples, HDDs 226 or SSDs 228, which are physical storage devices, and an Ethernet interface 229 for connecting to the management computer 10.

These network interfaces for connecting to the physical storage devices and another computer are not limited to those in accordance with the standards described in this embodiment and may be those in conformity with other standards as long as each of them has a function capable of achieving the same purpose.

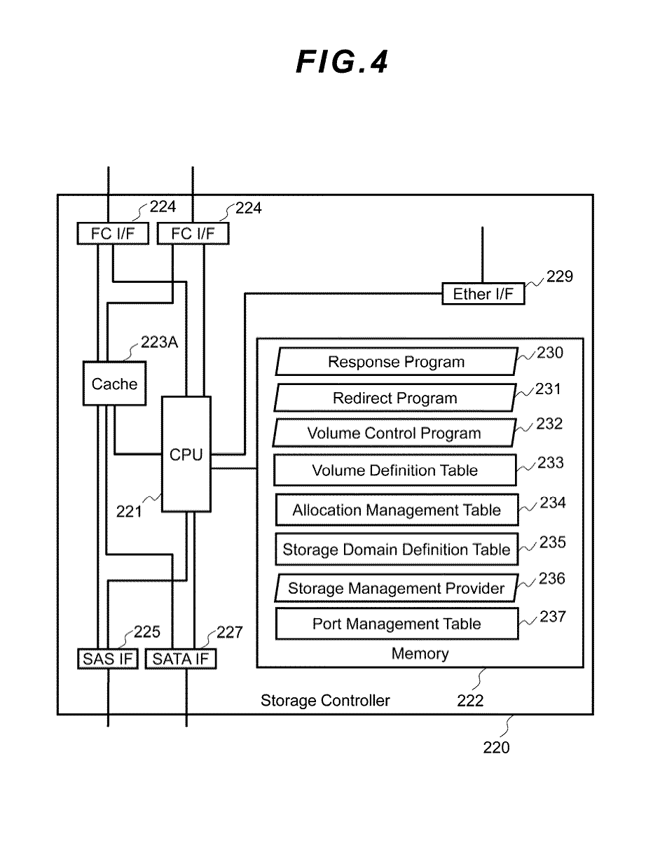

FIG. 4 shows an example of an internal structure of the storage controller 220. A memory 222 for the storage controller 220 stores a response program 230, a redirect program 231, a volume control program 232, a volume definition table 233, an allocation management table 234, a storage domain definition table 235, a storage management provider 236, and a port management table 237; and a CPU 221 executes necessary operations for processing of these programs.

A cache 223A temporarily stores data when the data is read from, or written to, the physical storage devices (the HDDs 226 or the SSDs 228).

The response program 230 responds to at least READ CAPACITY/READ/WRITE commands from the physical servers and other storage apparatuses.

The redirect program 231 provides a storage virtualization function called external connection in this embodiment and implements processing for redirecting access to the storage apparatus 22-1 of a first CPF 20 (for example, the CPF 20-1) to the storage apparatus 22-2 of a second CPF 20 (for example, the CPF 20-2). The detailed behaviors of this program will be explained later.

The volume control program 232 implements volume generation/deletion/configuration change processing for providing storage areas of the physical storage devices, which are provided in the storage apparatus 22, as volumes to the physical servers. The configuration of each volume is managed as a record in the volume definition table 233 by the volume control program 232.

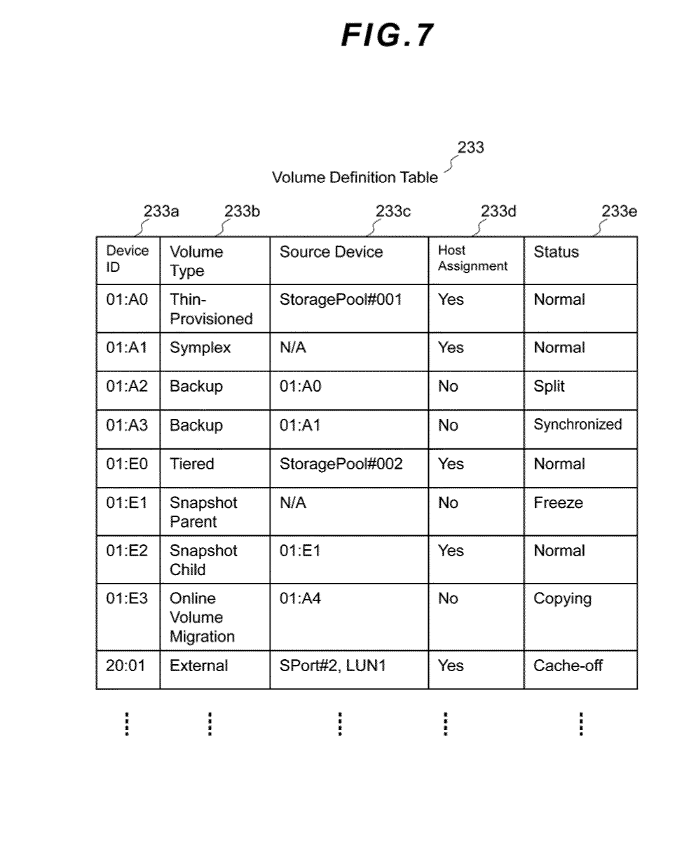

The volume definition table 233 shown in FIG. 7 has each of the following fields: a device identifier 233a for uniquely identifying a volume in the relevant device or system; a volume type 233b showing an attribute; a source device 233c showing a related source volume if the relevant volume is associated with another volume; a host assignment flag 233d showing whether the relevant volume is connected to a physical server or not; and a status 233e showing the current status of the volume.

The volume control program 232 can set validation/invalidation of the cache 223 A with respect to each volume and may retain this as the status 233e in the volume definition table 233 or another field for retaining the setting of the cache may be provided separately. The volume type 233b managed by the volume definition table 233 will be explained later together with functions provided by the storage apparatus 22.

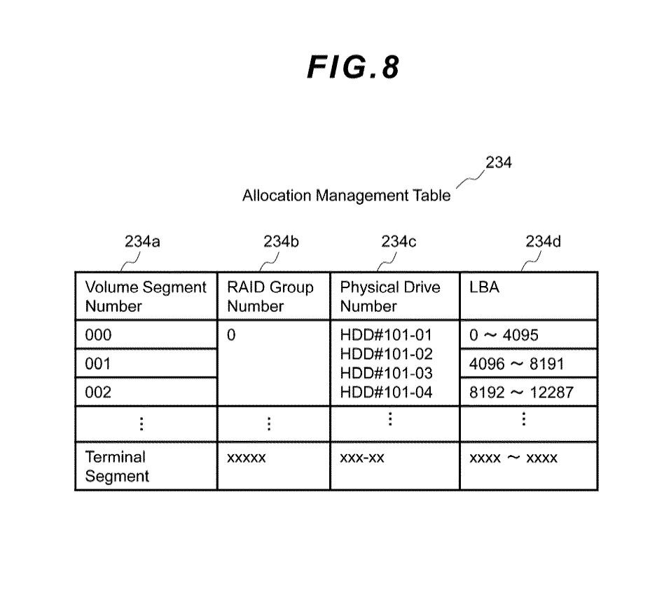

As described earlier, each area of the physical storage devices is managed as a volume. The allocation management table 234 shown in FIG. 8 serves to associate an address in the volume (segment number) with an LBA (Logical Block Addressing) of the physical storage device (physical disk drive) and is created or changed by the volume control program 232. Access from the physical server to the volume is executed by designating the volume segment number 234a and the response program 230 refers to each field of the allocation management table 234, designates an LBA area in an actual physical disk drive, and accesses it, thereby making it possible to read or write data. Each field of the table shown in FIG. 8 shows an example of a case where the RAID (Redundant Arrays of Independent Disks) technique is used for the configuration.

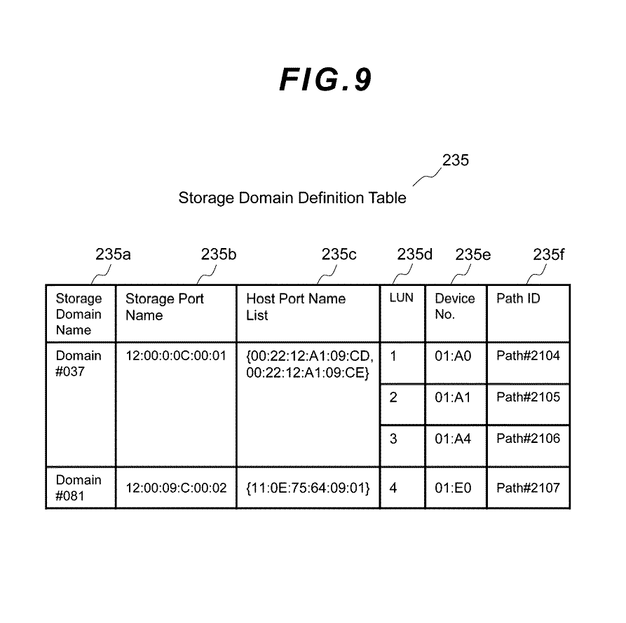

Access by the physical server to a volume is controlled in accordance with an access range defined by the storage domain definition table 235 (see FIG. 9) which is edited by the volume control program 232. The storage apparatus provides storage resources to a plurality of physical servers and it is necessary to control access by associating the physical servers with the volumes in order to guarantee consistency of data retained in the volumes as a result of reading and writing asynchronously issued by various physical servers. This is realized by a basic technique, which is generally called LUN masking, for storage management by using the Fibre Channel.

In this embodiment, the storage domain definition table 235 defines a range in which the physical server can access the storage apparatus, by designating a network port name 235c of one or more physical servers to a network port name 235b on the storage apparatus side; and this range will be hereinafter referred to as the storage domain. The storage domain is assigned a unique domain name 235a in the storage apparatus.

At the same time, a unique LUN (Logical Unit Number) 235d is set to each volume and the physical server included in the host (physical server) port name field 235c identifies the relevant volume as a disk drive based on this LUN 235d. When a volume is associated with a storage domain in this way, the LUN 235d is always set. On the other hand, a storage domain which is not associated with any volume may exist. A logical access path that associates a volume with (a network port of) a physical server via the LUN is called a path; and the path has a unique path identifier 235f in the storage apparatus.

The storage management provider 236 (see FIG. 4) provides an interface for having the storage apparatus 22 managed by the management computer 10. Specifically speaking, the storage management provider 236 provides commands or API (Application Program Interface) to remotely make the storage manager of the management computer 10 execute the procedure for, for example, operating the volume control program 232 in the storage apparatus 22 and referring to the volume definition table 233 and the storage domain definition table 235.

The management provider 236 is incorporated from the beginning by a vender who supplies the storage apparatus. A means for communicating with the storage management provider 236 is limited to a means capable of realizing a storage management function and uses a language such as HTML or XML or a management protocol such as SMI-S (Storage Management Initiative—Specification). The storage management interface is also mounted on, for example, the physical server 21 and enables management software of the management server to refer to and set the configuration.

The management provider 236 may be mounted in the storage controller in a form, for example, as application software or an agent operating on the OS or as a function of part of another program used to control the storage apparatus. Furthermore, the management provider 236 may be mounted in dedicated hardware (such as an integrated circuit chip).

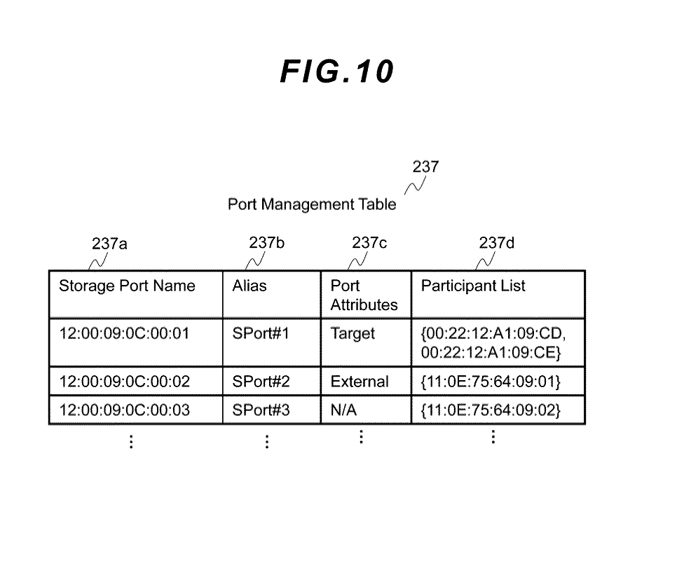

All ports mounted on the Fibre Channel interfaces 224 in the storage controller 220 are managed by the volume management program 232, using the port management table 237 (FIG. 10). The port management table 237 retains: a port name 237a which is unique for each port; an alias 237b which is arbitrarily set by the administrator; port attributes 237c; and a list of achievable port names 237d. The port attributes 237c are assigned to a port identified by the port name 237a.

For example, when the port accepts access from the physical server, “Target” is set to the port attributes 237c; and when the port is configured for external connection, “External” is set to the port attributes 237c. The achievable port name list 237d retains port names in a state capable of sending/receiving data to/from the relevant port. Therefore, if connectivity of both ports is secured logically, port information can be described in the port name list 237d even if data is not actually sent or received between the ports.

Furthermore, when defining a storage domain in the storage domain definition table 236 shown in FIG. 9, the administrator may obtain a record corresponding to the storage-side port name 235b from the port management table 237, select a port to connect to the storage-side port from the port name list 237d, and sets it as the host-side port name 235c.

Characteristic functions of the storage apparatus are realized by each program in the storage controller 220 of the storage apparatus 22-1 of the first CPF 20 (for example, the CPF 20-1). An external connection function as one of these characteristic functions is realized as follows. A volume of the second storage apparatus 22-2 of the second CPF 20 (for example, the CPF 20-2), which is separate from the first CPF 20, is provided to a physical server 21-n of the first CPF 20-1 via the network 40 between the storage apparatus 22-1 of the first CPF 20-1 and the storage apparatus 22-2 of the second CPF 20-2 as if it were a volume in the storage apparatus 22-1 of the first CPF 20-1.

Conventionally, the physical server 21-n of the first CPF 20-1 could use a volume(s) provided by the second storage apparatus 22-2 of the second CPF 20-2 only by performing inter-volume data copying between the first storage apparatus 22-1 of the first CPF 20-1 and the second storage apparatus 22-2 of the second CPF 20-2, which requires a long time; however, the external connection function does not require the inter-volume data copying and is realized by redirecting access, which has been made from the physical server 21-n of the first CPF 20-1 to the storage apparatus 22-1 in the same CPF 20-1, to the network 40 mutually connecting the storage apparatus 22-1 of the first CPF 20-1 and the second storage apparatus 22-2 of the second CPF 20-2 and further returning a response from the second storage apparatus 22-2 of the second CPF 20-2 through the intermediary of the storage apparatus 22-1 of the first CPF 20-1 to the physical server 20-n of the first CPF 20-1.

The following method can be assumed as a method for implementing the external connection function in the storage apparatus. Volumes in the target second storage apparatus 22-2 of the second CPF 20-2 to which the external connection is applied are set so that they can be used through a port logically different from a port connected to the physical server 21-n of the second CPF 20-2. How to do this is the same as the case where volumes are provided to a physical server. Furthermore, the network 40 for mutually connecting the storage apparatus 22-1 of the first CPF 20-1 and the second storage apparatus 22-2 of the second CPF 20-2 is provided and a target volume is logically associated with a volume for the external connection within the storage apparatus 22-1 of the first CPF 20-1.

This volume for the external connection is defined in the storage apparatus 22-1 of the first CPF 20-1, but no actual physical storage devices (for example, the physical drives 226 or 228) are allocated to that volume, so that it is called a virtual volume. However, even a virtual volume can use the cache and the copy function in the same manner as other volumes in the storage apparatus 22-1 of the first CPF 20-1.

The volume for the external connection is defined by the volume control program 232 and is registered in the volume definition table 233. For example, if a volume whose device identifier 233a is “20:01” in FIG. 7 is the volume for the external connection, “External” is set to the volume type 233b and necessary information to access the volume in the second storage apparatus 22-2 of the second CPF 20-2 is registered in the source device field 233c.

Referring to FIG. 7, the source device field 233c shows that a volume which can be accessed from a storage port (alias “SPort#2”) of the first storage apparatus 22-1 of the first CPF 20-1 via LUN 1 is a volume in the storage apparatus 22-2 of the second CPF 20-2 (having the physical storage devices).

Therefore, when the physical server 21-n of the first CPF 20-1 issues access to the external connection volume “20:01,” the response program 230 refers to the volume type field 233b and identifies it as the externally connected volume and the redirect program 231 transfers the access to the source device, thereby enabling reading/writing of the volume in the storage apparatus 22-2 of the second CPF 20-2.

Examples of copy functions of a storage apparatus(es) include: a replication function that creates a duplicate volume between storage apparatuses via a SAN; a remote copy function that creates a duplicate volume between storage apparatuses at different sites by using a wide area network; and a volume backup function that creates a duplicate volume within a storage apparatus.

Examples of storage capacity efficiency functions include: a volume snapshot function that saves only a changed part of a specified volume to another volume; and a volume thin provisioning function that forms a pool by gathering a plurality of volumes and adds a capacity to the volumes in units smaller than the volumes in response to a write request from the physical server.

An example of a storage migration function is an online volume migration function that migrates the content retained by a certain volume defined in a chassis to another volume without stopping by performing volume copying and switching the identification information in cooperation with switching of an access path.

These functions are applied to volumes as targets and are managed by a volume type 132d in a volume management table 132.

A network using the Fibre Channel statically has a unique address called a WWN (World Wide Name) at each network port of an individual network adapter (host bus adapter [HBA]). There is a unique WWN across a plurality of devices and there is no redundant WWN over the same network. Furthermore, when a network port is connected to the network, a dynamic address called an arbitrated loop physical address or a native address identifier is assigned to the port, depending on topology.

These addresses are disclosed within a range permitted by access control and arbitrary equipment which is logically connected to the same network can refer to such addresses. Unless otherwise specified, the WWN or its alias (another name used at equipment over the network) is used in this embodiment; however, the techniques and methods disclosed in this embodiment are not limited by the type of an assigned address. The above-mentioned addresses correspond to a MAC address and an IP address over an IP network and do not limit an applicable range of this embodiment to the Fibre Channel.

Referring to FIG. 2, the physical server manager 123 manages physical server(s) and virtual server(s) configured in the physical servers. For example, regarding the first physical server 21-1 of a certain CPF 20 (for example, the CPF 20-1), the physical server manager 123 communicates with a physical server management provider mounted in the virtualization software 217 or the OS 216 of this physical server and thereby obtains configuration information and performance information of the physical server and changes its configuration. The physical server management provider is incorporated into the physical server from the beginning by the vender who supplies the server. The physical server manager 123 mainly manages the configuration and performance information of the physical servers by using a virtual disk management table 136 and physical server information 135.

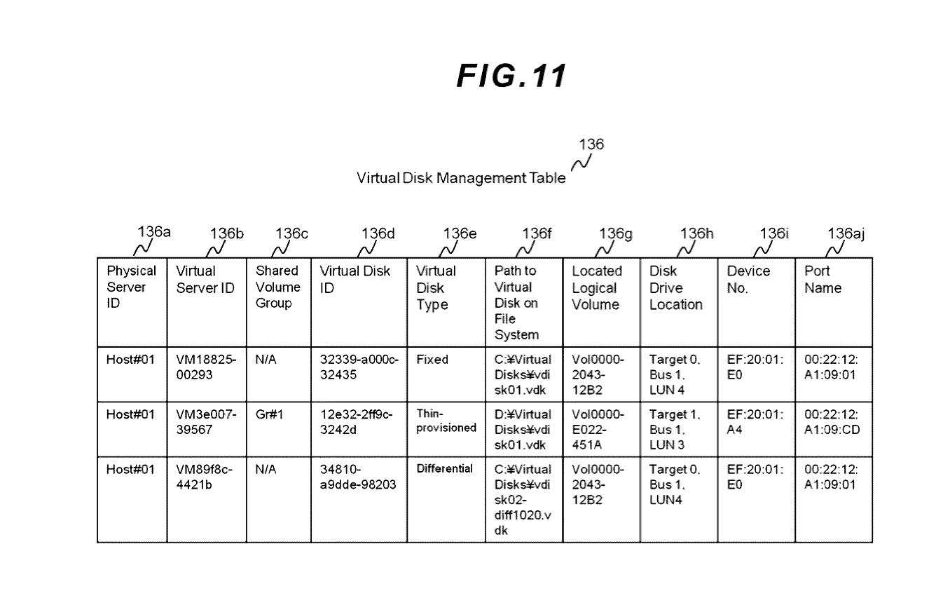

The details of the virtual disk management table 136 are shown in FIG. 11. The virtual disk management table 136 is used to record the locations of virtual disks connected to virtual servers and retains a physical server identifier 136a indicating the physical server where the relevant virtual server is located, a virtual server identifier 136b, a shared volume group 136c, a virtual disk identifier 136d, a virtual disk type 136e, a path 136f indicating the location of the virtual disk in the file system, a located logical volume 136g, a connection location 136h of a storage location disk drive for the physical server, a device identifier 136i assigned to that disk drive, and a connection destination port name 136j on the network interface. All these pieces of configuration information can be obtained from the OS or the virtualization program on the physical server.

The shared volume group 136c indicates the configuration, in which a plurality of physical servers connect to the same volume, and means a group of physical servers for enabling migration of a virtual server between the physical servers for the purposes of load distribution and maintenance.

There are a plurality of formats of virtual disks. A first format is a format in which files are stored in volumes (recognized as a physical disk drive by the physical server) mounted on the physical server. The physical server recognizes the volumes as the physical disk drives. A virtual disk of the first format contains files that can be created with, for example, fixed capacity, variable capacity, and differential capacity, respectively. A second format is a format in which volumes are connected as physical disk drives to the virtual server.

If a virtual disk is configured in the file format, the virtual disk management table 136 further retains the path 136f which indicates the location in the directory structure. A file system is sometimes configured by further dividing the inside of the disk drives into one or more logical volumes (or partitions) and the physical server retains the logical volume 136g, which is a storage location of the logical volumes, in order to manage the logical volumes.

The disk drive connection location 136h is expressed in accordance with the SCSI standards by combining the LUN, which is determined by the OS or the virtualization program, and identification numbers of the target and a SCSI bus.

The port name (WWN) which is used to connect to the network for connecting the physical server and the storage apparatus (for example, the Fiber Channel 23) is retained in the connection destination port name field 136j.

The OS or the virtualization program assigns a unique device number 136i to the disk drive by, for example, using the device identifier 133a which the physical server can obtain from the storage apparatus.

The virtual disk management table 136 may further retain a flag for identifying whether a built-in disk drive or a storage apparatus via a Fibre Channel, or the type of a connection interface (such as IDE or SCSI) with them, or the type of a file system; or if a virtual disk of the file format is retained in a file server over the network, a flag for identifying it may be retained in the virtual disk management table. However, these pieces of configuration information are limited to those which can be managed by the OS or the virtualization program on the physical server.

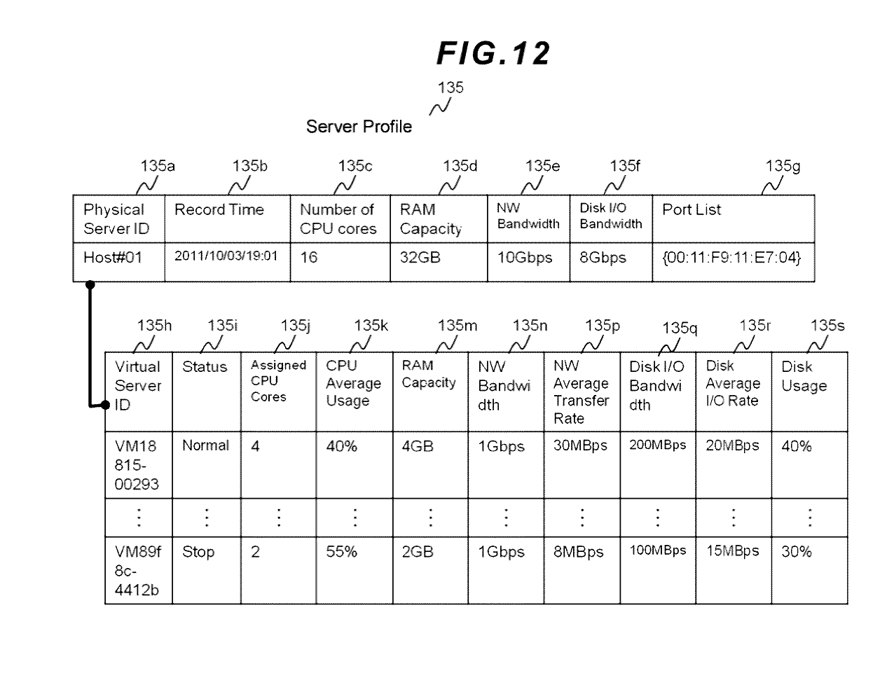

The physical server information 135 shown in FIG. 12 is designed so that a record created for each physical server is associated with a table created for virtual server(s) on the relevant physical server for the purpose of recording performance information of the physical server and the virtual servers.

The performance information of the physical server retains, for example, the number of logical CPU cores 135c, a memory capacity 135d, a network bandwidth 135e, a disk I/O bandwidth 135f, and a port name list 135g for Fibre Channel corresponding to a physical server identifier 135a, together with time 135b when the information was obtained by the physical server manager 123. Regarding these pieces of the performance information of the physical server, other parameters may also be retained as necessary only with respect to those which can be obtained by the physical server manager 123.

The performance information of the virtual server retains, for example, the number of logical CPU cores 135j, CPU average usage 135k, a memory capacity 554m, a network bandwidth 135n, a network average transfer rate 135p, a disk I/O bandwidth 135q, a disk average I/O rate 135r, and disk usage 135s that are assigned corresponding to a virtual server identifier 135h on the physical server, together with the status of the virtual server (for example, in operation or Stop) 135i. Regarding these pieces of the performance information of the virtual server, other parameters may also be retained as necessary only with respect to those which can be obtained by the physical server manager 123.

For example, if the virtualization program 217 uses a technique for dynamically changing the memory to be allocated to a virtual server, depending on load on, for example, the virtual server (memory ballooning), the dynamic memory capacity may be added to the performance information of the virtual server. The physical server manager 123 calculates the used amount of resources consumed in the physical server and the performance by summing up the performance information about the virtual server on the physical server. However, if the virtualization program 217 or the OS 216 consumes the resources of the physical server separately from the virtual server, this may be taken into consideration for the calculation.

The storage manager 122 manages storage apparatuses. For example, the storage manager 122 communicates with the storage management provider 236 provided in the storage controller 220 of the storage apparatus 22-1 of a certain CPF 20 (for example, the CPF 20-1) and can thereby obtain the configuration information of the storage apparatus and change its configuration.

In this embodiment, the storage manager 122 manages the configuration of storage apparatuses by using the volume management table 132, a storage domain management table 133, and a volume mapping table 134. Additionally, if necessary, the storage manager 122 can refer to the allocation management table 234 and the port management table 237 of the storage controller 220 and change their settings.

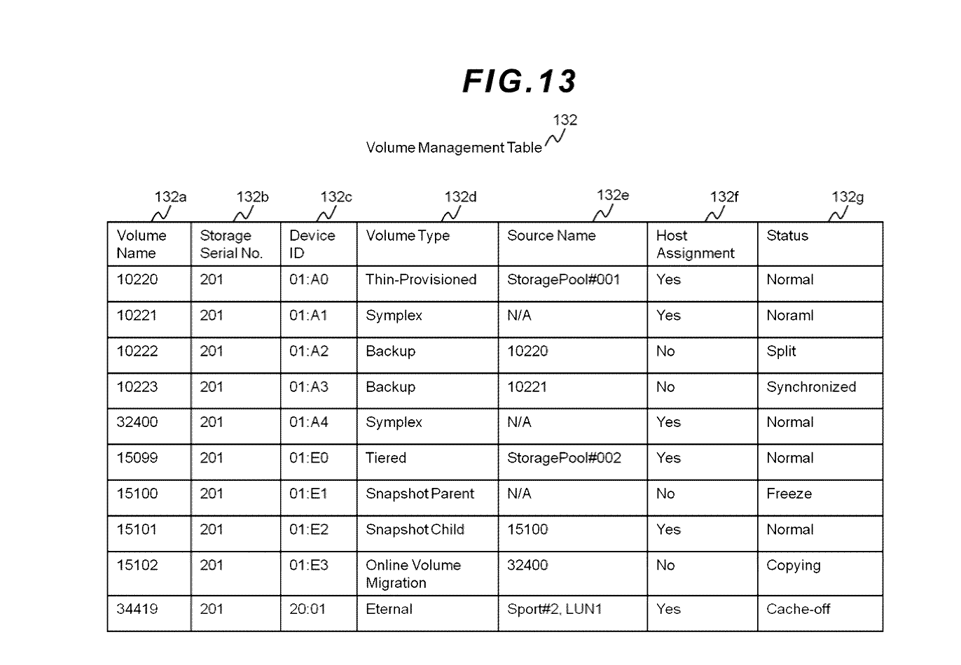

The volume management table 132 shown in FIG. 13 retains configuration information corresponding to the content of the volume definition table 233 which the storage apparatus has in the storage controller. However, in addition to the content of the volume definition table 233, the volume management table 132 retains a storage serial number 132b for uniquely identifying the relevant storage apparatus and a volume name 132a for uniquely identifying the relevant volume with respect to all the storage apparatuses which are targets of the storage manager 122.

These identifiers are added because the volume management table 132 needs to manage volumes with respect to one or more storage apparatuses, while, for example, the volume definition table 233 of the storage apparatus 22-1 of the CPF 20-1 manages only volumes within the same apparatus.

As long as the volume name 132a is unique, a naming convention may differ depending on the implementation of the storage manager 122 in the management computer. For example, when adding a record to the volume management table 132, the storage manager 122 may generate a volume name so as to form a serial number or may generate a volume name by combining the storage serial number 132b and the device identifier 132c.

Furthermore, the storage manager 122 can set validation/invalidation of the cache with respect to each volume by operating the volume control program 232 and may retain this information in the volume management table 132.

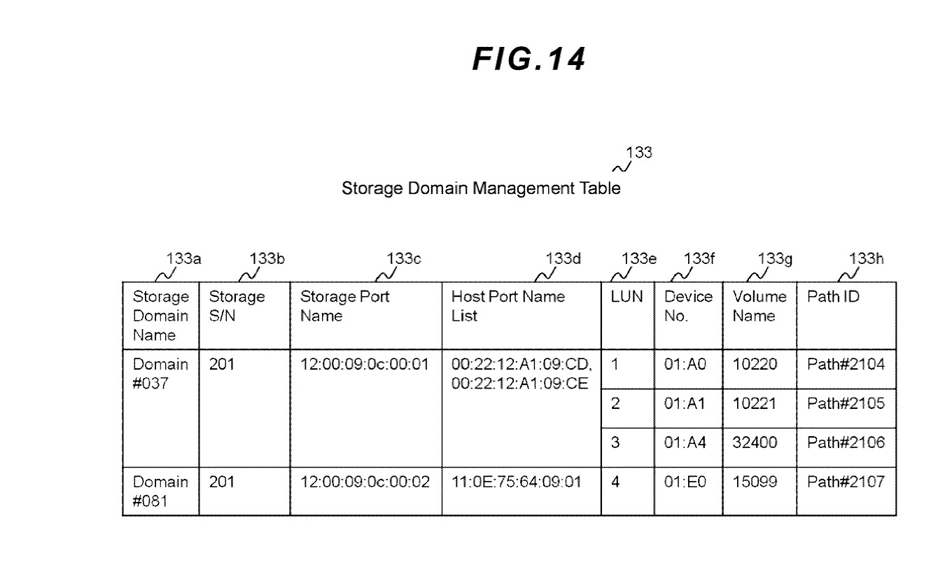

The storage domain management table 133 shown in FIG. 14 retains configuration information corresponding to the content of the storage domain definition table 235 which the storage apparatus has in the storage controller. The storage domain management table 133 retains a storage serial number 133b for uniquely identifying the relevant storage apparatus and a volume name 133g for uniquely identifying the relevant volume with respect to all the storage apparatuses because of the same reason as the case of the volume management table 132.

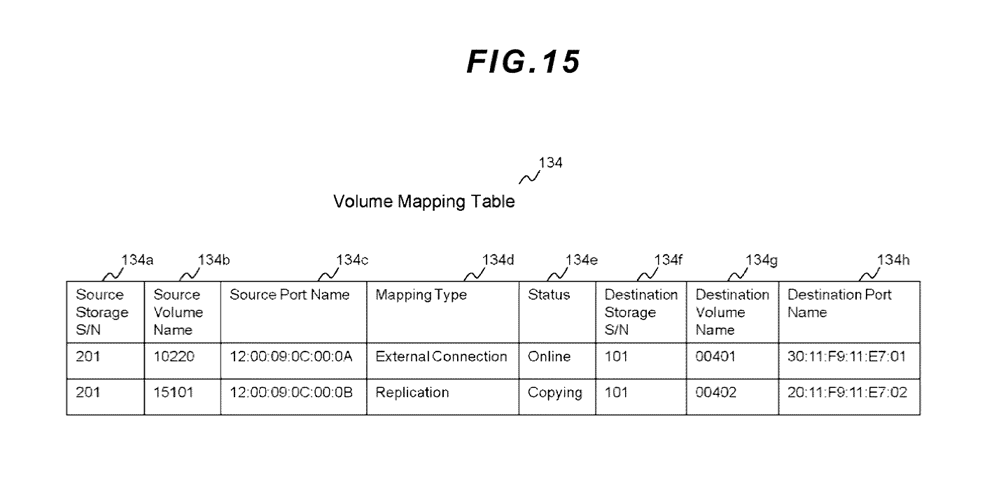

The volume mapping table 134 shown in FIG. 15 retains the connection relationship between volumes in preparation for the use of the storage functions by the management server across a plurality of storage apparatuses. This table retains a mapping source storage serial number 134a, a mapping source volume name 134b, a mapping source port name 134c, a mapping destination storage serial number 134f, a mapping destination volume name 134g, and a mapping destination port name 134h, together with a mapping type 134d and the status 134e.

For example, a first record associates a volume, which is located in a device with a serial number “201” and whose volume name is “10220,” with a volume, which is located in a device with a serial number “101” and whose volume name is “00401,” by means of the external connection function and shows that the status is “Online.” Accordingly, it can be found that access to the (virtual) volume managed with the volume name “00401” is redirected normally by means of the external connection function to the volume managed with the volume name “10220.” Furthermore, a record on the second row is an example showing application of volume copying (replication) between the storage apparatuses.

The network manager 121 manages the network for connecting the storage apparatuses of the CPFs 20. For example, the network manager 121 obtains configuration information and changes the configuration information by communicating with the storage controller 220 of each storage apparatus 22.

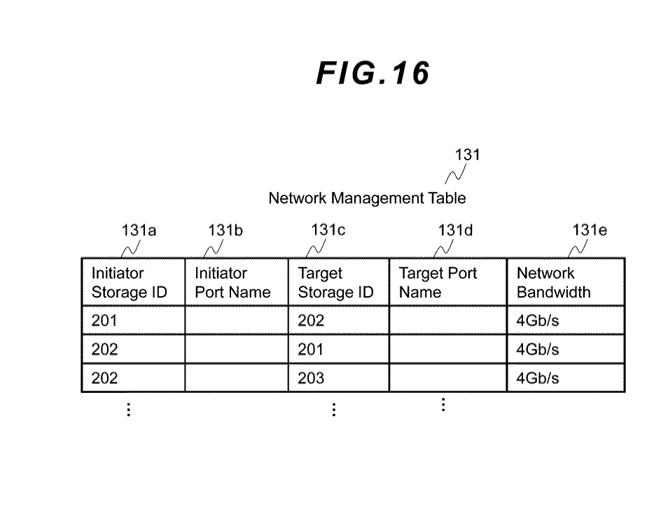

A network management table 131 shown in FIG. 16 manages an identifier (storage serial number) 131a of each storage apparatus 22, a port name 131b for external connections of the storage apparatus 22 with the identifier 131a, an identifier 131c of a storage apparatus 22-n to which the storage apparatus 22 is externally connected, a port name 131d of the “Target” storage apparatus 22-n with the identifier 131c, and a network bandwidth 131e between the storage apparatus 22 with the identifier 131a and the storage apparatus with the identifier 131c.

The CPF manager 124 manages CPFs. The CPF manager 124 obtains the physical server management table 135 managed by the physical server manager 123 and the network management table 131 managed by the network manager 121 and manages the relationship between the physical server 21-n in each CPF 20, the virtual server 218-n in each physical server 21-n, and the storage apparatus 22. For example, the virtual servers 218-1, 218-2 operate on the physical server 21-1 of the CPF 20-1 and the storage apparatus 22-1 extracts the configuration information and connection information about the external connection with the storage apparatus 22-2 of the CPF 20-2 from the physical server management table 135 and the network management table 131. Now, the CPF manager 124 may extract performance information of the physical servers and the virtual servers from the physical server management table and use it, for example, when selecting a migration destination of a virtual server.

The migration controller 125 is a characteristic program of the present invention and realizes migration of a virtual server between physical servers and migration of a virtual disk between storage apparatuses by cooperating with the physical server manager 123, the storage manager 122, the network manager 121 and the CPF manager 124. The migration is performed by using a connection means (such as an IP network or inter-process communication) capable of mutual connection between a migration source and a migration destination, and a management interface disclosed. The migration controller 125 manages the connection relationship between virtual servers and virtual disks by using a target mapping table 137 and a volume attachment design table 138 and maintains this connection relationship before and after the migration.

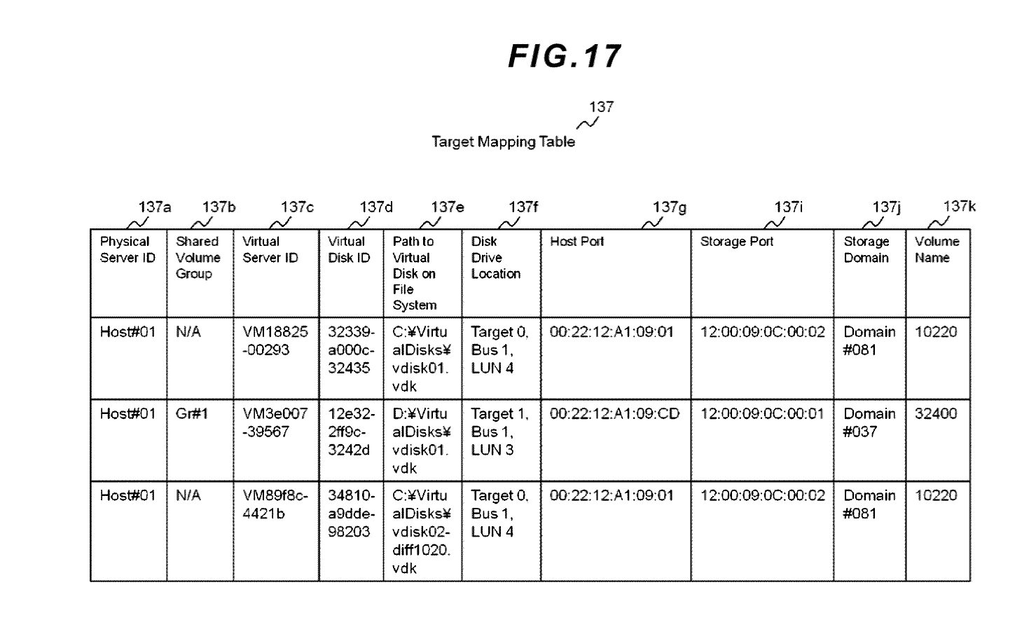

The target mapping table 137 shown in FIG. 17 is used to manage the connection relationship between virtual servers, virtual disks and volumes and retains at least the number of records equal to the number of virtual disks that can be recognized by the physical server manager 123. Therefore, each record always includes a physical server identifier 137a, a virtual server identifier 137c, a virtual disk identifier 137d, and a storage location volume name 137k.

Other identification parameters may be included in the records if they are necessary for the migration and as long as they can be obtained indirectly from the management program 120 or directly from the management provider. For example, a shared volume group 137b, a path on the file system 137e, a disk drive connection location 137f, a physical-server-side port 137g, a storage-side port 137i, and a storage domain 137j may be included.

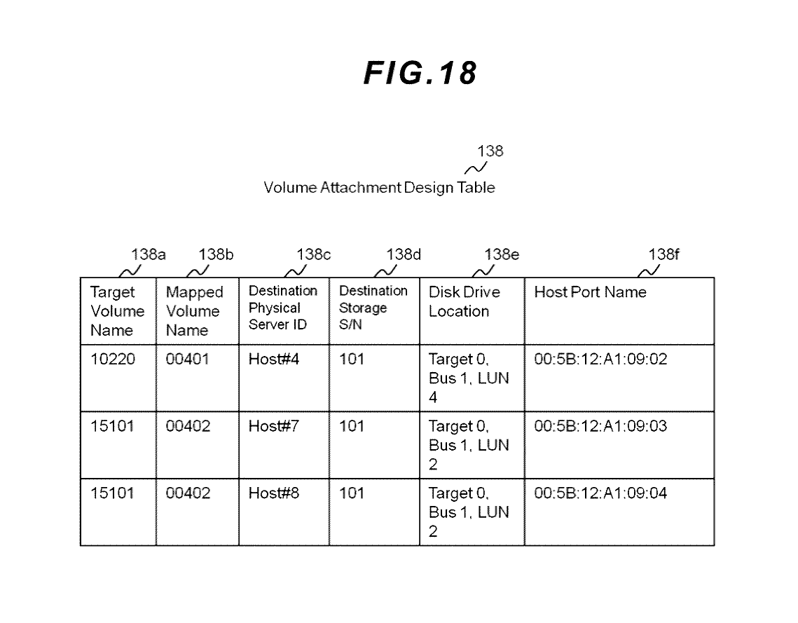

The volume attachment design table 138 shown in FIG. 18 retains settings of how migration target volume(s) at migration destination(s) should be connected to physical server(s). This table 138 retains, with respect to a volume name 138a of a volume migrated (or scheduled to be migrated), a migration destination volume name 138b, a physical server identifier 138c of the migration destination, a disk drive connection location 138e, and a port 138d of a connection destination physical server; and creates the number of records equal to the number of paths defined between volumes at the migration destination and ports on the physical server.

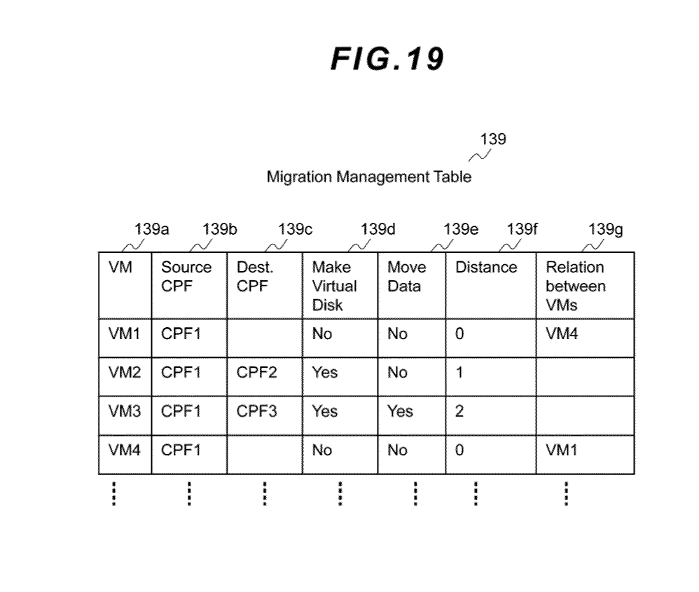

A migration management table 139 shown in FIG. 19 retains settings indicating whether a CPF containing a physical server, on which a migration source virtual server operates, and a CPF containing a migration destination physical server, to which the virtual server is migrated, are the same or not, and whether it is necessary to generate a virtual volume or not, whether to also migrate data or not, and the relationship with other VMs.

This table 139 includes various control information such as: an identifier 139a of a migration target virtual server; an identifier 139b of a CPF containing a migration source physical server where the virtual server 139a operates; an identifier 139c of a CPF containing a migration destination physical server; information 139d indicating whether it is necessary to generate a virtual disk or not; information 139e indicating whether or not data is also to be migrated to the storage apparatus to which the virtual server migration destination CPF is connected; information 139f indicating the distance between the storage apparatus of the migration source CPF and the storage apparatus of the migration destination CPF; and information 139g indicating whether or not there is any dependency relationship with applications operating on the virtual server. For example, when temporarily migrating the virtual server to another CPF different from the migration source CPF and then returning it to the migration source CPF, the information 139e is set. Furthermore, regarding the information 139g, for example, when VM1 and VM4 send and receive data via the storage apparatus between the activated applications and, therefore, it is desirable that VM1 and VM4 should exist in the same CPF, the distance “0” is set to the information 139e.

Now, a method for obtaining the configuration information when using the function(s) of the storage apparatuses in order to migration a virtual server to a physical server with a different storage apparatuses to be connected will be explained.

In order for the management server 10 to migrate a virtual server by using the function(s) of storage apparatuses, when a certain virtual server at a migration source is designated as a migration target, it is necessary to specify a volume, to which the storage functions should be applied, that is, a migration target volume which stores a virtual disk used by the relevant virtual server. However, as described earlier, programs for managing the respective devices such as storage apparatuses, servers, or networks are basically specialized and designed to manage layers such as servers, networks, or storage apparatuses for which they are responsible. Therefore, generally, no program capable of managing across a plurality of layers constituting the system exists.

Furthermore, in order for the storage manager 122 to apply the storage functions to the migration target volume, the administrator has to designate the target volume by using an identifier (for example, the volume name 132a) which can be interpreted by the storage manager 122. However, there is no guarantee that the identifier used by the physical server manager 123, which manages the locations of virtual disks, in order to specify a volume as a physical disk drive is the same as the identifier used by the storage manager 122. For example, the physical server generates a device identifier including a response for a SCSI Inquiry command or a volume-specific identifier (for example, the device number 136i) based on the device identifier, while the storage manager 122 uniquely generates the volume name 132a as a logical identifier for management.

The reason for this is, for example, that because volumes which are not disclosed to the storage apparatus or the physical server exist, these volumes have to be logically distinguished. For example, when the storage apparatus is equipped with a function that makes a volume such as a copied volume, which is physically different from a copy source volume, take over a device identifier of the copy source volume and changes an access target volume without making the physical server become aware of a configuration change, that is, an online volume migration function, the device identifier determined by the SCSI standards would be the same, but the copy source volume and the copy destination volume have to be operated as different volumes in terms of storage management and another identifier for the management purpose should be provided separately from the device identifier (the identifier disclosed to the physical server).

So, the management computer identifies and specifies a volume not based on a device-specific identifier, but based on location information used when connecting the volume to a physical server. For example, the LUN which is assigned for each HBA port according to the SCSI standards corresponds to the location information. While the device-specific identifier is unique among all devices, the LUN is unique for a (physical-server-side) port of an initiator.

The device-specific identifier is always unique and the device-specific identifier can also correspond on a one-to-one basis to the content recorded in the volume. The device-specific identifier is used to identify the identity of a volume as seen from the physical server, for example, when the volume is shared by a plurality of physical servers or when multi-path software for controlling a plurality of paths for the same volume is configured.

The server can examine the identity of the volume based on the device-specific identifier according to an Inquiry command without reading the entire content of connected volumes and comparing the volumes. Such a device-specific identifier is generally used for identification operation inside the server device and is not disclosed to the management program outside the device. Accordingly, when examining this device-specific identifier, it is necessary to introduce a program (agent), which is capable of issuing an Inquiry command, to the physical server and specially providing an interface.

On the other hand, the LUN is one type of a dynamic address simply indicating in what number of order the relevant volume (logical unit) is connected so that the physical server can access the volume; and is not used for the purpose of identifying the content of the volume across a plurality of servers. For example, a route for a physical server to connect to a volume can be changed as in a case where, for example, a volume which has been mounted in a certain physical server can be made to be used in another physical server by assigning an LUN which is different from its former LUN.

The identifier indicating a port and the LUN are necessary address information to realize connection between the respective devices as determined by the SCSI protocol and can be easily obtained by the management program 120 on the management server 10 via the management provider of each device. It is an out-of-band method because the management provider or the management program specifies the address information through the network outside the device.

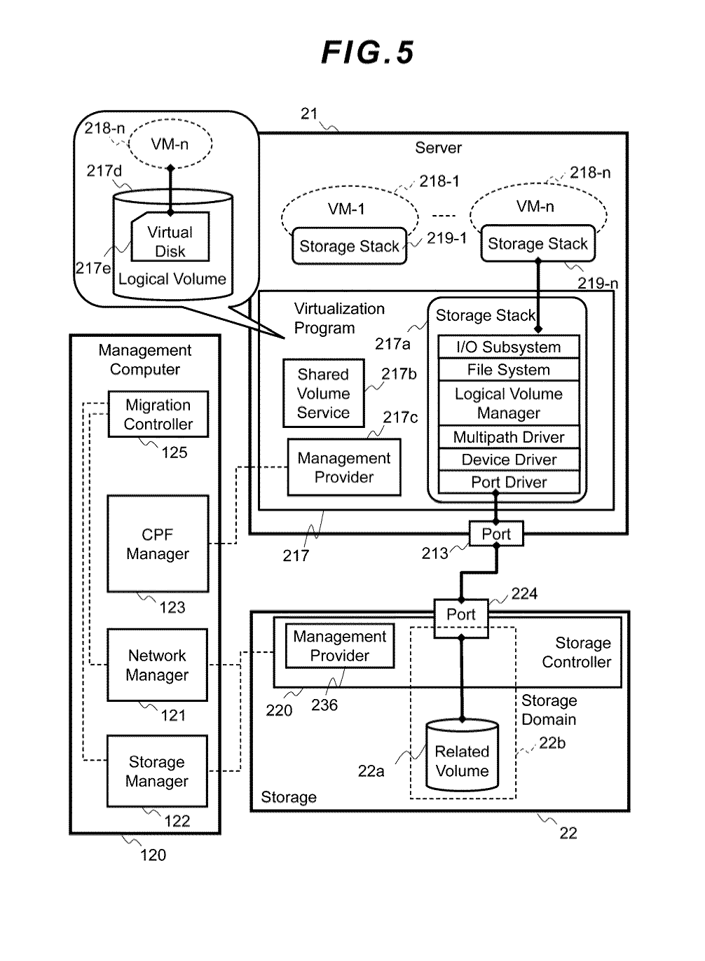

FIG. 5 illustrates the configuration of the physical server 21 and the storage apparatus 22. The management program 120 on the management server 10 obtains the configuration information in each device through the management provider 217c, 236 in each device.

A virtual server 218 operates in a logical space provided by the virtualization program 217. There are various implementation methods of the virtualization program 217. Hardware of the physical server is provided as certain logically divided hardware to users. The logically divided hardware operates in the logical space.

As shown in this drawing, for example, access to a disk is made via hardware abstracted by a hierarchized structure called a storage stack 217a. Similarly, a virtual server whose content is to operate in the logical space obtained by dividing the hardware also accesses the virtual disk via the storage stack 219 realized by the OS of the virtual server.

In the case of this drawing, a virtual disk 217e used by the virtual server 218 is managed as a file of the file system defined on a logical volume 14d by the storage stack of the virtualization program 217. The virtual disk 217e is recognized by the virtual server 218 as if it were a physical disk drive connected via the storage stack 219.

Depending on how the virtualization program 217 is mounted, there is also a format in which a logical volume is directly accessed without the intermediary of the file format (path-through-disk format) for the purpose of avoiding overhead mainly caused by access to the logical volume through the intermediary of a plurality of layers of the storage stack.

A storage area in a layer at or below a logical volume manager of the storage stack 217a is managed as one volume (or physical disk drive). A multi-path driver controls a plurality of paths for the same volume and realizes load distribution or fail-over of disk access. A device driver or a port driver absorbs the difference between the storage apparatuses and the network adapters and enables access from an upper-level layer in the same manner by a READ/WRITE command regardless of the mounting form of such equipment in the server.

As explained earlier, the management computer uses, as volume specifying information, an LUN which is information specifying the connection location of the volume and can be obtained from the device driver (or a logical volume manager), and a port WWN which can be obtained from the port driver. If the path used by the multi-path driver is changed dynamically, port information may sometimes be concealed from upper layers, so that a currently used port is specified by referring to path control information managed by the multi-path driver.

On the other hand, a storage domain 22b is defined in the storage apparatus 22 and the storage domain is associated with a port 213 on the host (physical server 21) side. Furthermore, at which LUN a volume 22a is provided to the physical server 21 (or the host-side port 213) is defined in this storage domain 22b.

Furthermore, the virtualization program 217 retains information indicating which LUN is assigned to a physical disk drive that stores the virtual disk 217e used by the virtual server 218. Here, the volume in the storage apparatus 22 which is used by the virtual server 218 is uniquely specified by comparing the LUN used by the physical server 21 with the LUN, which is set on the storage apparatus 22, with respect to the host-side port 213.

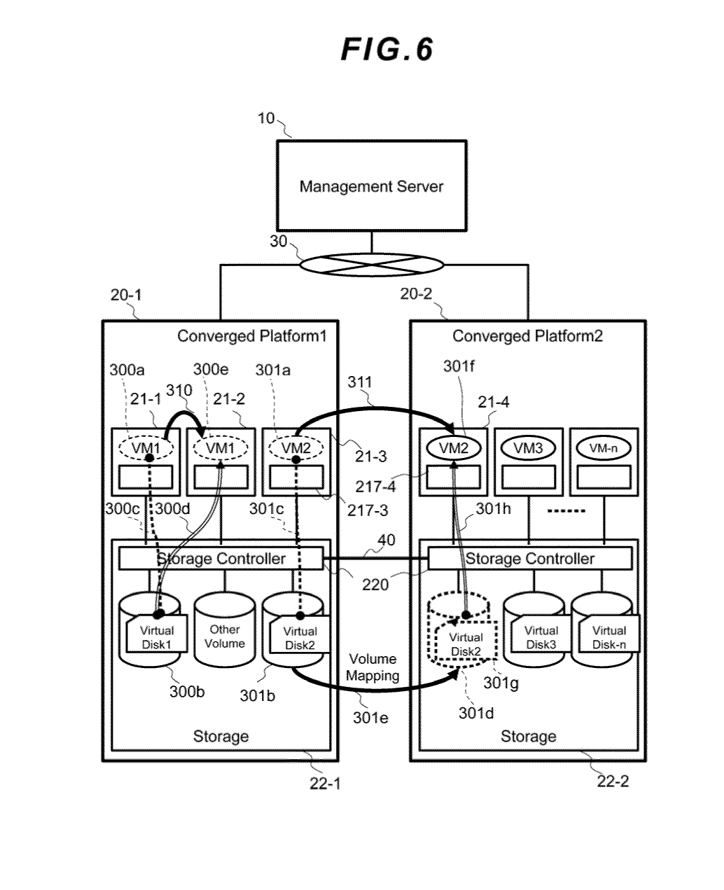

A conceptual diagram of the migration method is shown in FIG. 6. FIG. 6 shows: a first case 310 where a virtual server 300a operating on a first physical server 21-1 (source physical server: virtual server migration source) contained in a CPF 20-1 is migrated to a second physical server 21-2 (destination physical server: virtual server migration destination) of the same CPF 20-1; and a second case 311 where a virtual server 301a operating on a third physical server 21-3 in the CPF 20-1 is migrated to a fourth physical server 21-4 of a CPF 20-2 different from the CPF 20-1.

The migration controller 120 of the management server 10 generates a virtual volume and judges whether to migrate data or not, depending on whether the CPF of the migration destination physical server of the virtual server is the same CPF as the CPF of the migration source physical server.

The first case 310 will be explained. The migration destination physical server (21-2) is selected according to the usage of the resources allocated to the migration target virtual server 300a (such as the CPU, the memory, and the disk I/O bandwidth rate) and the resources of the physical servers 21-1, 21-2 before and after the migration. If the physical server 21-2 is selected, the physical server 21-2 is contained in the same CPF 20-1 as that of the migration source physical server 21-1, so that the virtual server 300a can be migrated by sharing the volume 300b in the storage apparatus 22-1 storing the virtual disk used by the virtual server 300a.

The second case 311 will be explained below. If it is determined to migrate the migration target virtual server 301a to the physical server 21-4 contained in the CPF 21-2 different from the CPF 21-1 containing the physical server 21-3 where the virtual server 301a operates, the migration controller 125 obtains the configuration information from the management program 120, specifies the volume 301b, and sets the external connection setting 301e to associate the volume 301b with the virtual volume 301d in the storage apparatus 22-2 of the CPF 20-2.

In a pre-migration state, the physical server 21-3 and the storage apparatus 22-1 are directly connected, the virtual server 301a operates on the physical server 21-3, and the virtual disk of the virtual server 301a operates on the storage apparatus 22-1. Under this circumstance, the physical server 21-3 and the storage apparatus 22-1 are respectively managed by the physical server manager 123, the storage manager 122, and the network manager 121 on the management server 10.

The migration controller 125 obtains the configuration information from the physical server 21-3, which is the migration source, and the storage apparatus 22-1 through the above-mentioned management programs 120 in order to execute the migration processing. The migration controller 125 manages the obtained configuration information by using the target mapping table 137; and when the migration administrator designates the virtual server 301a to be migrated, the migration controller 125 specifies the volume 301b storing the corresponding virtual disk.

Subsequently, the administrator designates the migration destination physical server and, if necessary, the storage apparatus to the management server 10. The migration controller 125 retains the designated content in the volume attachment design table 138. This table includes not only a field for the migration destination physical server, but also fields about the logical location and the network port; however, they may be calculated by the migration controller 125 in accordance with a specified algorithm or may be set by the administrator. The algorithm may be of the known content and may be an algorithm having the ability to judge whether or not the migration destination physical server and the migration destination storage apparatus have an unused capacity equivalent to a total capacity of required resources which is estimated by referring to the physical server information 135 with respect to at least the migration target virtual server.

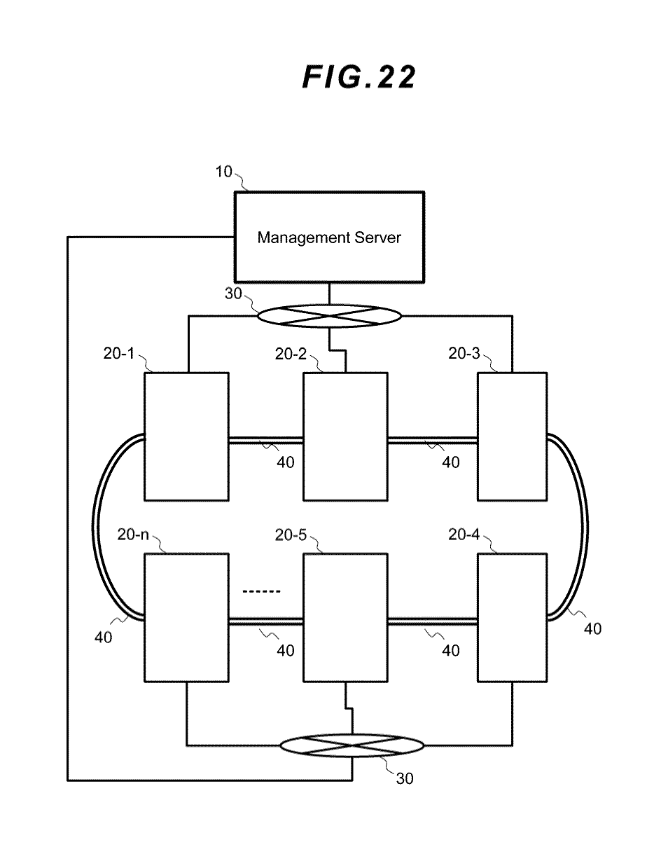

Furthermore, the migration destination physical server and the migration destination storage apparatus may be decided by the CPF manager 124 in consideration of the distance between the CPF 20-1, to which the migration source storage apparatus 22-1 belongs, and the CPF 20-2 to which the migration destination storage apparatus 22-2 belongs. The distance between the CPFs 20 is set to, for example, “0” in a case of migration between the physical servers in the same CPF 20 or “1” in a case of migration between the physical servers in the CPFs 20 whose storage apparatuses 22 are directly connected. If there are three CPFs 20 in the computer system and, for example, the CPFs 20 are connected in a ring form as shown in FIG. 22, for example, the distance between the CPF 20-1 and the CPF 20-3 may be set to “2” because the connection is routed through the CPF 20-2.

Furthermore, when selecting the migration destination physical server, the influence of migration of the virtual server upon the applications can be mitigated by further considering the dependency relationship indicating that the applications operating on the migration target virtual server communicate frequently with other applications operating on other physical servers.

For example, in a case where application A for receiving input data from an external data source, obtaining information such as a creator of the relevant data and creation time, executing preprocessing for, for example, data format conversion, and outputting the data to the storage, and application B for obtaining the data output from the application A as input data and executing processing for extracting characteristics of the obtained data are in operation, it is desirable that application A and application B exist in the same CPF. The dependency between application A and application B can be expressed as the distance and treated in the same manner as the distance between the CPFs by setting, to 139g of the migration management table 139, a virtual server having the dependency relationship and the distance to that relevant server as, for example, “0” if the virtual servers need to exist in the same CPF.

The migration controller 125 makes the volume 301d accessible from the migration destination physical server 21-4, so that it thereby makes the same volume 301b accessible from both the physical server 21-4 and the physical server 21-3 and sets this volume 301b as a shared volume. Then, a virtual server nonstop migration function 311 is used between the virtualization programs 217-3 and 217-4 and the virtual server 301a in the physical server 21-3 is migrated to the physical server 21-4.

When the migration controller 125 finishes migrating all virtual servers which store virtual disks in the volume 301b, the shared volume setting is canceled. If necessary, the migration controller 125 may execute the procedure for migrating data retained by the migration source volume 301b to another volume in the storage apparatus 22-2 by using the online volume migration function of the storage apparatus 22-2 of the migration destination CPF 20-2.

If the virtual server migration function 311 requires a function locking volumes in the storage apparatus in order to perform exclusive control of the shared volume, the locked state of the migration source volume 301b may be obtained and synchronized with the locked state of the virtual volume 301d in the migration destination storage apparatus 22-2. For example, the migration controller 125 manages the locked state of the migration source volume 301b and the virtual volume 301d by using the storage manager 122 and further synchronizes it with lock control of the shared volume service of the virtualization programs 217-4 and 217-3 by using the physical server manager 123. Furthermore, when the migration controller 125 sets the external connection 301e, the locked state of the volume 301b and the volume 301d may be matched in the storage apparatus 22-2.

Furthermore, when the shared volume is configured, it should be recognized, in the environment where volumes are accessed by a plurality of physical servers via separate paths, that the volumes accessed by the respective physical servers are actually the same volume. The identity of the volumes means that the content such as attributes retained by each volume is essentially the same; and it is necessary to check the content as an advance requirement to configure the shared volume.

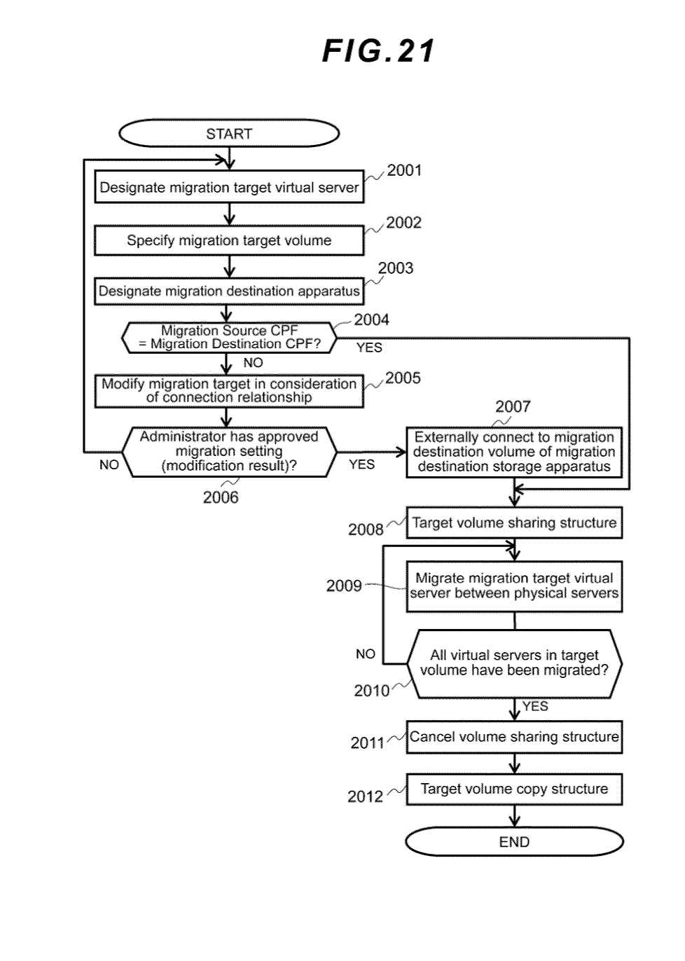

The detailed migration procedure will be explained with reference to a processing flow diagram shown in FIG. 21. In step 2001, the administrator who carries out the migration operation designates a migration target virtual server, for example, 21-3, to the migration controller 125.

The migration controller 125 obtains management information such as the virtual server identifier 136b of the physical server 21-3, which is a migration source, and its virtual disk identifier 136d by using the physical server manager 123 in advance. The physical server manager 123 regularly invokes the management provider in the physical server 21-3 and updates the management table so that it can always manage the latest configuration information; however, the physical server manager 123 may perform this update operation at the time of migration.

If it is necessary for authentication to obtain information from the management program 120 in step 2001, the migration controller 125 may demand that the administrator should input the administrator authorization registered in the management program 120. Since the acquisition of the configuration information of each device constituting the computer system by the management server 10 from each device is based on the out-of-band method as explained earlier, it is important to enhance security and prevent interception of information sent and received over the management network 30 by third parties.

In step 2001, the migration controller 125 firstly creates an empty target mapping table 137; and as triggered by designation of a virtual server as the migration target by the administrator, the migration controller 125 creates one record. Information relating to the migration source physical server 21-3 such as the physical server identifier 137a, the virtual server identifier 137c, the virtual disk identifier 137d, the path on the file system 137e, the disk drive location 137f, and the host-side port 137g is copied from the virtual disk management table 136 to the above-mentioned record.

In step 2001, the migration controller 125 refers to each configuration information of the migration source physical server 21-3 and the storage apparatus 22-1, which is provided by the physical server manager 123 and the storage manager 122; and then edits the target mapping table 137 with respect to the migration target virtual server and the virtual disk, which are designated in step 2001; and designates the migration target volume name 137k.

The target mapping table 137 retains the disk drive location 137f, in which the virtual disk that is the migration target is stored in step 2001, and the host-side port 137g. With respect to these pieces of information, the migration controller 125 refers to the storage domain management table 133 through the intermediary of, for example, the storage manager 122, compares it with the host-side port name list 133d and the LUN 133e, and thereby designates the volume name 133g of the migration target (step 2002).

The specified volume name 133g is copied to the volume name field 137k of the target mapping table 137. Furthermore, values of the storage-side port 133c and the storage domain name 133a relating to the specified volume are also copied with respect to the port 137i connected to the migration target volume, and the storage domain 137j.

Now, the migration controller 125 may detect the dependency relationship between, for example, virtual servers and virtual disks and add the virtual server and the volume, which should be migrated at the same time, as a new record to the target mapping table 137. As a method for detecting the dependency relationship, the migration controller 125 may sometimes search the virtual disk management table 136 and the volume management table 132 by using the specified volume as a key value and reversely look up information about the virtual server which should be migrated at the same time.

In step 2003, the administrator designates the physical server 21-4, which is the migration destination with respect to each migration target virtual server to the migration controller 125. It is desirable that a physical server, which satisfies the performance requirements of resources allocated to the physical server and applications made to operate on the virtual server, or a physical server having a short distance between the migration source physical server and the migration destination physical server should be designated as the migration destination physical server. Since the migration destination volume is automatically created as explained later, it is not designated in this step. Therefore, the migration controller 125 obtains the configuration information of each device via the physical server manager 123 and the storage manager 122 in advance.

Furthermore, the migration controller 125 creates the volume attachment design table 138 with respect to the migration target volume designated in step 2002 in accordance with the designation by the administrator. The volume attachment design table 138 retains the migration setting indicating at which location of which physical server 21-4 the migration destination volume should be connected. The migration destination physical server identifier 138c, the migration destination storage serial number 138d, the disk drive location 138e, and the host-side port name 138f, which are input by the administrator, or input by the migration controller 125 in accordance with a specified algorithm, to the volume name 138a of the migration target, are entered in the volume attachment design table 138.

The migration controller 125 has the storage manager 122 issue a volume, which is not a duplicate of other volumes, as a migration destination volume and the storage manager 122 enters this in the migration destination volume name field 138b. A method for inputting the setting items of the volume attachment design table 138 is, for example, as follows.

As the administrator refers to the target mapping table 137, which was created in step 2002, with respect to the virtual server designated by the administrator as the migration target in step 2001, the migration target volume name 137f can be obtained, thereby identifying the migration target volume name 138a of the volume attachment design table 138.

If the administrator designates the migration destination physical server 138c in step 2003, the migration controller 125 obtains the port name used by the migration destination physical server 138c from the port name list 135g of the physical server information 135.

In step 2004, the migration controller 125 judges whether or not the CPF 20 containing the migration destination physical server is the same CPF as the CPF 20 containing the migration source physical server, by searching the CPF management table 131. For example, referring to FIG. 6, the physical servers 21-1 and 21-2 are in the same CPF 20-1, so that in step 2008, the migration controller 125 migrates the virtual server by setting a virtual volume 300b as shared storage accessible from the migration source physical server and the migration destination physical server.

The migration controller 125 sets a path by using the port name used by the migration destination physical server 21-2, which was obtained in step 2003, so that the migration destination physical server 21-2 can see the virtual volume 300b. In step 2009, the migration controller 125 has the virtual server 300e of the migration destination physical server 21-2 take over information in the memory for the virtual server 300a by using the nonstop migration function of the virtualization program 217 and then the management server 10 connects the virtual volume 300e in the migration destination physical server 21-2 with a connection 300d with the virtual disk and migrates the virtual server 300a to the migration designation physical server 21-2.

In step 2010, the migration controller 125 judges whether all the virtual servers 300a using the migration target volume 300b have been migrated or not, by comparing the virtual server identifier 137c in the target mapping table 137 with the virtual server identifier 135h of the migration source physical server 21-1 which can be obtained from the physical server information 135 via the physical server manager 123. If there is any migration target virtual server 300a remaining in the migration source physical server 21-1, the migration controller 125 returns to step 2009 and repeats the processing for migrating the virtual server without stopping. In step 2011, the migration controller 125 cancels the volume sharing structure in the migration source physical server 21-1 by using the physical server manager 123 and disconnects the connection 300c between the virtual server 300a and the virtual volume 300b in the migration source physical server 21-1. The processing of step 2012 is not executed in a case of migration between different physical servers belonging to the same CPF as in the case of migration of the virtual server from the physical server 21-1 to the physical server 21-2.

On the other hand, the migration destination physical server 21-3 and the migration destination physical server 21-4 are different CPFs, so that they are connected to different storage apparatuses 22. The migration controller 125 uses the port name used by the migration destination physical server 138c as a key and compares it with the host-side port name list 133d of the storage domain management table 133 in the migration destination storage apparatus 22. If a storage domain including the port name of the migration destination physical server has already been defined, the volume name 133g connected to the migration destination physical server 138c and its LUN 133e and the storage domain name 133a can be found. In this case, it is only necessary to define a new migration destination volume by assigning the LUN so that the relevant volume would not become a duplicate of other existing volumes in the existing storage domain.

If the relevant record does not exist in the storage domain management table 133, the migration controller 125 searches the port management table 237 for a record of the port name 237d which can be connected to the migration destination physical server and includes the port name of the migration destination physical server 21-4. If the migration controller 125 successfully detects the port to be connected to the migration destination physical server, the administrator creates a new storage domain at the relevant storage-side port and defines a new migration destination volume.

The status of use of the storage-side port is managed in the port management table 237 and the storage manager 122 can refer to this. However, the configuration information defined in the volume attachment design table 138 cannot be reflected to the device yet at the stage of step 2003, so that the configuration of the device is not actually changed.

The migration controller 125 can set the migration destination storage serial number 138d and the disk drive location 138e as described above. A plurality of paths may exist between the migration destination physical server and the migration destination volume, depending on the number of ports of the physical server 21-4 and the number of ports of the storage apparatus 22-2; and records as many as the number of defined paths are created in the volume attachment design table 138.

In step 2005, the migration controller 125 can construct a path for external connection by using the network manager 121 and checks if the configuration designated in the volume attachment design table 138 can be constructed. More specifically, the migration controller 125 refers to the storage domain configuration of the storage apparatuses and verifies that the external connection 301e between the storage apparatuses and physical connectivity when providing the storage resources from the migration destination storage apparatus 22-2 to the migration destination physical server 21-4 can be obtained, that this is not limited by the specification of each device, and that the relevant identifier is not a duplicate of other identifiers.

If the verification results are inappropriate, the migration controller 125 cancels the designation of the relevant virtual server for migration of the virtual server or changes the values designated by the administrator, thereby modifying the target mapping table 137 and the volume attachment design table 138.

In step 2006, the migration controller 125 presents the settings for migration to an operator based on the target mapping table 137 and the volume attachment design table 138. If the migration controller 125 obtains an approval of the administrator for the settings for migration, it proceeds to the next step 2007; and if the migration controller 125 fails to obtain the approval of the administrator for the settings for migration, it returns to step 2001 and makes the settings again. Incidentally, if the approval of the administrator is obtained, migration of the virtual server, which is the migration target, to the physical server 21-n other than the migration destination may be prohibited by means of the virtual server migration function of the virtualization program 217-4.

In step 2007, the migration controller 125 sets the volume mapping table 134, the storage domain management table 133, and the volume management table 132 through the storage manager 122 in accordance with the volume attachment design table 138. The storage manager 122 changes the configuration of the migration destination storage apparatus 22-2 and the migration source storage apparatus 22-1 in accordance with the settings made by the migration controller 125 and applies the external connection function to the migration target volume.

Specifically speaking, the migration controller 125 connects the storage apparatus 22-1 and the storage apparatus 22-2 at the Fibre Channel interface 40 via the storage manager 122, sets the migration destination volume 301b as a virtual volume, maps the migration target volume 301b to the migration destination volume 301d, and connects the migration destination virtual server 301f to the migration destination volume 301d as described later, so that the migration destination virtual server 301f can access the migration target volume 301b by accessing the migration destination volume 301d.

If the external connection setting is completed in step 2008, the storage manager 122 issues a setting completion notice to the migration controller 125 and sets a path from the physical server 21-4 to the mapping destination virtual volume 301d. The migration controller 125 validates the shared volume service 217b, if necessary, by using the physical server manager 123 and constitutes the volume 301b as the shared volume.

In step 2009, the migration controller 125 migrates the virtual server 301a, which is defined in the target mapping table 137, to the physical server 21-4 by using the physical server manager 123.

In step 2010, the migration controller 125 compares the virtual server identifier 137c of the target mapping table 137 with the virtual server identifier 135h in the migration source physical server 20, which can be obtained from the physical server information 135 through the physical server manager 123, and then judges whether all the virtual servers 301a which use the migration target volume 301b have been migrated or not. If the migration target virtual server 301a remains in the migration source physical server 21-3, the migration controller 125 returns to step 2009 and repeats the virtual server nonstop migration processing.

In step 2011, the migration controller 125 cancels the volume sharing structure in the migration source physical server 21-3 by using the physical server manager 123 and blocks access from the migration source physical server 21-3 to the volume 301b. Step 2011 may include the procedure executed by the storage manager 122 for cancelling the path setting.

In step 2012, the migration controller 125 has the storage manager 122 migrate the content of the volume 301b to another volume in the migration destination storage apparatus 22-2 by means of the online volume migration function as described earlier, if necessary. Subsequently, the migration controller 125 sets the connection relationship between the volumes 301b and 301d (for example, volume copy) to the volume mapping table 134 via the storage manager 122.

The migration system according to this embodiment relates to migration of a virtual server which operates on a CPF for directly connecting servers and a storage apparatus and consolidating them in the same chassis; judges whether a migration source physical server and migration destination physical server of the virtual server which is a migration target exist in the same CPF; uses a virtual server migration function of the virtualization program without generating a new virtual volume in a case of migration between the physical servers in the same CPF; and can migrate the virtual server without stopping it in a case of migration between the physical servers in different CPFs, by utilizing the external connection function and the online volume migration function of the storage apparatus in cooperation with the nonstop virtual server migration function of the virtualization program. The system composed of CPFs has a shared storage structure, in which a plurality of servers are directly connected to the same storage apparatus in a CPF, and an external storage apparatus connection structure between CPFs. The external storage connection function requires generation of a virtual volume in the virtual server migration destination in advance. This uses resources of the storage apparatus (the controller and disks). Since the storage apparatus is shared in the case of migration of a physical server in a CPF, it is unnecessary to generate a new virtual volume and the migration can be performed by switching a path. Wasteful use of the resources of the storage apparatus can be avoided by changing the migration processing by judging whether the physical server which is the migration destination of the virtual server exists in the CPF or in a different CPS. Particularly, in a state where many virtual servers more than several hundreds of virtual servers operate along with the recent increase of the number of server cores, the migration system of this embodiment is effective in preventing I/O performance degradation of the virtual servers in operation.

Incidentally, it is possible to assume the use of the migrated virtual server, that is, to return to the physical server where the migrated virtual server originally operated. For example, there is a possible use case in which a CPF which is used for an application for another usage during the day and is not operated during the night may be used to distribute loads of applications operated at any hour of day or night. If a virtual server which operates on a physical server of the CPF operating during the day is migrated to, and made to operate on, a physical server of a CPF, which is not operating only during the night, and the virtual server is returned to the physical server of the original CPF in the morning, it is possible to avoid wasteful consumption of a storage capacity by deleting a virtual volume generated in a storage apparatus of the CPF which contains the physical server migrated during the night. After the migration of the migration target virtual server is completed, whether data of the migration target virtual server designated in step 2001 is also to be migrated or not is obtained from the migration management table 139 in step 2011; and in a case of the virtual server whose data is not to be migrated, cancellation of the volume sharing structure in S2011 and any subsequent steps will not be executed. For example, regarding VM2 in the migration management table 139, CPF2 which is a migration destination is a CPF different from the migration source CPF 1; and since the data migration is specified as NO, the setting is made so that VM2 should be returned to the migration source CPF1 and, therefore, it is unnecessary to execute step S2011 and any subsequent steps. On the other hand, if it is designated to also migrate data of the virtual server, the volume sharing structure is canceled.

Incidentally, the present invention is not limited to the aforementioned embodiments, and includes various variations. For example, the aforementioned embodiments have been described in detail in order to explain the invention in an easily comprehensible manner and are not necessarily limited to those having all the configurations explained above. Furthermore, part of the configuration of a certain embodiment can be replaced with the configuration of another embodiment and the configuration of another embodiment can be added to the configuration of a certain embodiment. Also, part of the configuration of each embodiment can be deleted, or added to, or replaced with, the configuration of another configuration.

Furthermore, part or all of the aforementioned configurations, functions, processing units, processing means, and so on may be realized by hardware by, for example, designing them in integrated circuits. Also, each of the aforementioned configurations, functions, and so on may be realized by software by processors interpreting and executing programs for realizing each of the functions. Information such as programs, tables, and files for realizing each of the functions may be retained in memories, storage devices such as hard disks and SSDs (Solid State Drives), or storage media such as IC cards, SD memory cards, and DVDs.

Furthermore, control lines and information lines that are considered to be necessary for the explanation are indicated and not all control lines or information lines are necessarily indicated with respect to products. It may be assumed that almost all components are connected to each other for the sake of implementation.

### REFERENCE SIGNS LIST

10 Management server
20 Converged platform
21 Sever
22 Storage apparatus
30 Ethernet
40 Storage area network
120 Management program
121 Network manager
122 Storage manager
123 Sever manager
124 CPF manager
125 Migration controller
217 Virtualization program
218 Virtual server
220 Storage controller

1. A computer system comprising a plurality of computers, each of which includes:
a plurality of physical servers; and
at least one storage apparatus directly connected to the plurality of physical servers;
the computer system comprising:
a management device;
a first network for connecting the plurality of computers to the management device; and
a second network for connecting the respective storage apparatuses of the plurality of computers to each other;
wherein when migrating a virtual server, which operates in a first physical server of a first computer among the plurality of computers, to another physical server other than the first physical server,
if it is determined that the other physical server exists in another computer different from the first computer, the management device copies data stored in a storage area used by the virtual server to a storage apparatus of the other computer via the second network; and
if the other physical server exists in the first computer, the management device does not copy the data stored in the storage area used by the virtual server.

2. The computer system according to claim 1, wherein if the other physical server exists in the first computer, the management device sets a volume of a storage apparatus of the first computer having the storage area used by the virtual server as a volume accessible from a second physical server in addition to the first physical server.

3. The computer system according to claim 1, wherein if the other physical server exists in the other computer, the management device maps a volume of a storage apparatus of the first computer having the storage area used by the virtual server to a virtual volume, which is set to the other computer, so that the volume can be accessed via the virtual volume; and
If the copying of the data stored in the storage area used by the virtual server is completed, the management device associates a volume, which is a destination of the copying, with the virtual volume.

4. A computer system comprising a plurality of computers, each of which includes:
a plurality of physical servers; and
at least one storage apparatus directly connected to the plurality of physical servers;
the computer system comprising:
a management device;
a first network for connecting the plurality of computers to the management device; and
a second network for connecting the respective storage apparatuses of the plurality of computers to each other;
wherein when migrating a virtual server, which operates in a first physical server of a first computer among the plurality of computers, to another physical server other than the first physical server,
if the other physical server exists in the first computer, the management device sets a volume of a storage apparatus of the first computer having a storage area used by the virtual server as a volume accessible from a second physical server in addition to the first physical server; and
if the other physical server exists in the other computer, the management device maps a volume of the storage apparatus of the first computer having the storage area used by the virtual server to a virtual volume, which is set to the other computer, so that the volume can be accessed via the virtual volume.

5. A virtual server migration control method for a computer system with a management device for managing a plurality of computers, each of which includes a plurality of physical servers and at least one storage apparatus directly connected to the plurality of physical servers,
wherein if the management device selects another physical server other than a first physical server in a first computer among the plurality of computers as a migration destination of a virtual server which operates in the first physical server in the first computer among the plurality of computers, the management device judges whether the other physical server exists in the first computer or exists in another computer different from the first computer among the plurality of computers; and
if the virtual server is to be migrated from the first physical server to the other physical server existing in the other computer as a result of the judgment result, the management device resets a correspondence relationship between the virtual server and a storage area used by the virtual server to the other computer to which the other physical server belongs.

6. The virtual server migration control method according to claim 5, wherein if the other physical server exists in the first computer, the management device sets a volume of a storage apparatus of the first computer having the storage area used by the virtual server as a volume accessible from a second physical server in addition to the first physical server.

7. The virtual server migration control method according to claim 5, wherein the management device:
specifies a migration target volume existing in a storage apparatus of the first computer, which stores data stored in the storage area used by the virtual server;
sets a virtual volume for the migration target volume to a storage apparatus of the other computer;
sets a connection relationship between the virtual server and the storage area stored in the migration target volume to the virtual volume; and
maps a migration source volume to the virtual volume so that the migration source volume is accessed from the virtual server via the virtual volume.

8. The virtual server migration control method according to claim 7, wherein when copying of data of the migration source volume to a migration destination volume existing in a storage apparatus of the other computer is completed, the management device associates the migration destination volume with the virtual server.

9. The virtual server migration control method according to claim 5, wherein after mapping the migration target volume to the virtual volume, the management computer disconnects a path between the virtual server of the first physical server and the migration target volume and
sets a path from the other physical server to the virtual volume.

10. The virtual server migration control method according to claim 5, wherein the management computer includes:
a first management program for managing configuration information of each of the first physical server and the other physical server; and
a second management program for managing configuration information of each of a storage apparatus of the first computer and a storage apparatus of a second computer in which the other physical server exists;
wherein the management computer obtains identification information of the migration target volume by checking first configuration information obtained by the first management program from the first physical server against second configuration information obtained by the second management program from the storage apparatus of the first computer;
wherein the first configuration information has positional information of the migration target volume when the first physical server connects to the migration target volume;
wherein the positional information has information of a port of the first physical server and a LUN for associating the port with the migration target volume;
wherein the second configuration information has domain information to make the first physical server accessible to the storage apparatus of the first computer;
wherein the domain information has the port information and the LUN; and
wherein the management computer obtains the identification information of the migration target volume by checking the port information and the LUN of the first configuration information against the port information and the LUN of the second configuration information.

11. The virtual server migration control method according to claim 6, wherein if the management computer sets migration of data of the migration target volume to the migration destination volume when migrating the virtual server from the first physical server to the other physical server, the management computer:
sets another volume different from the migration destination volume to a storage apparatus of the second computer;
copies the migration destination volume to the other volume by means of a copy function of the storage apparatus of the second computer; and
connects the second physical server to the other volume.

12. The virtual server migration control method according to claim 9, wherein the first physical server has a first virtualization program for virtualizing a server;
wherein the other physical server has a second virtualization program for virtualizing a server; and
wherein the management computer:
has the first virtualization program and the second virtualization program share the migration target volume;
migrates the virtual server from the first physical server to the other physical server without stopping;
cancels the sharing of the migration target volume by the first virtualization program;
blocks access from the first physical server to the migration target volume; and
sets the same identification information to the migration target volume and the migration destination volume.

13. The virtual server migration control method according to claim 12, wherein when the first physical server accesses the migration target volume, the management computer also makes the other physical server accessible to the migration target volume via the migration destination volume and invalidates cache data for the migration target volume of the storage apparatus of the first computer.

14. The virtual server migration control method according to claim 9, wherein if the virtual server migrated from the first physical server to the other physical server is managed to be re-migrated from the other physical server to the first physical server in the future, the management device does not migrate data stored in the storage area used by the virtual server from the first computer to the other computer; and
if the virtual server is re-migrated to the first physical server, the management device deletes the virtual volume of the storage apparatus of the other computer and
associates the migration source volume with the first physical server.

15. The virtual server migration control method according to claim 5, wherein the plurality of computers are connected in a ring form by directly connecting their storage apparatuses; and
wherein if a plurality of physical servers which can be the other physical server exist, the management computer selects a physical server of a computer located closest to a computer, to which the first physical server belongs, from among the plurality of computers as the other physical server.

16. The virtual server migration control method according to claim 5, wherein if a plurality of physical servers which can be the other physical server exist, the management computer selects a physical server, on which an application having a dependency relationship with an application operating on the virtual server, as the other physical server.
